(19) United States
(12) Patent Application Publication
(10) Pub. No.: US 2022/0261650 A1
(43) Pub. Date: Aug. 18, 2022

(54) MACHINE LEARNING TRAINING IN LOGARITHMIC NUMBER SYSTEM

(71) Applicant: NVIDIA Corp., Santa Clara, CA (US)

(72) Inventors: Jiawei Zhao, Pasadena, CA (US); Steve Haihang Dai, Union City, CA (US); Rangharajan Venkatesan, Sunnyvale, CA (US); Ming-Yu Liu, San Jose, CA (US); William James Dally, Incline Village, NV (US); Anima Anandkumar, Santa Clara, CA (US)

(73) Assignee: NVIDIA Corp., Santa Clara, CA (US)

(21) Appl. No.: 17/346,100

(22) Filed: Jun. 11, 2021

Related U.S. Application Data
(60) Provisional application No. 63/149,972, filed on Feb. 16, 2021.

(51) Int. Cl. G06N 3/08; G06F 7/483; G06F 7/487; G06F 5/01; G06F 1/03

(52) U.S. Cl. CPC G06N 3/084; G06F 7/4833; G06F 1/03; G06F 5/01; G06F 7/4876

(57) ABSTRACT

An end-to-end low-precision training system based on a multi-base logarithmic number system and a multiplicative weight update algorithm. The multi-base logarithmic number system is applied to update weights of the neural network, with different bases of the multi-base logarithmic number system utilized between calculation of weight updates, calculation of feed-forward signals, and calculation of feedback signals. The LNS expresses a high dynamic range and computational energy efficiency, making it advantageous for on-board training in energy-constrained edge devices.

### CROSS-REFERENCE TO RELATED APPLICATIONS

This application claims priority and benefit under 35 USC 119(e) to U.S. application Ser. no. 63/149,972, “Low-Precision Training in Logarithmic Number System using Multiplicative Weight Update”, filed on Feb. 16, 2021, the contents of which are incorporated herein by reference in their entirety.

### BACKGROUND

Implementing deep neural networks (DNNs) with low-precision numbers may improve the computational efficiency for both training and inference. While low-precision inference is now a common practice, low-precision training remains a challenging problem due to the complex interactions between learning algorithms and low-precision number systems. An important application of low-precision is learning neural networks in energy-constrained edge devices. Intelligent edge devices in many applications must adapt to evolving and non-stationary environments using on-device learning.

Deep neural networks have been widely used in many applications, including image classification and language processing. However, training and deploying DNNs usually require significant computational costs due to high precision arithmetic and memory footprint. Traditionally numbers in neural networks are represented by single precision floating-point (32-bit) or half-precision floating point (16-bit). However, these high-precision number formats may comprise redundancy and therefore may be quantized for training and inference while maintaining sufficient accuracy.

Recently, a multiplicative update algorithm called Madam, which focuses on optimization domains described by any relative distance measure instead of only relative entropy, has been proposed for training neural networks. Madam demonstrates the possibility to train neural networks under logarithmic weight representation. However, Madam requires full-precision training without connection to LNS-based low-precision training.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a basic deep neural network 100 in accordance with one embodiment.

FIG. 2 depicts an artificial neuron 200 in accordance with one embodiment.

FIG. 3 depicts a comparison of updating weights using Gradient Descent and Madam under logarithmic representation.

FIG. 4 depicts a DNN training algorithm data flow 400 and end-to-end low-precision training system in one embodiment.

FIG. 5 depicts a neural network training and inference system 502 in accordance with one embodiment.

FIG. 6 depicts a data center 600 in accordance with one embodiment.

FIG. 7 depicts a neural network processor 700 that may be configured to carry out aspects of the techniques described herein in accordance with one embodiment.

FIG. 8 depicts a local processing element 800 that may be configured to carry out aspects of the techniques described herein in accordance with one embodiment.

FIG. 9 depicts a parallel processing unit 902 in accordance with one embodiment.

FIG. 10 depicts a general processing cluster 1000 in accordance with one embodiment.

FIG. 11 depicts a memory partition unit 1100 in accordance with one embodiment.

FIG. 12 depicts a streaming multiprocessor 1200 in accordance with one embodiment.

FIG. 13 depicts a processing system 1300 in accordance with one embodiment.

FIG. 14 depicts an exemplary processing system 1400 in accordance with another embodiment.

FIG. 15 depicts a graphics processing pipeline 1500 in accordance with one embodiment.

### DETAILED DESCRIPTION

Disclosed herein are embodiments of an end-to-end low-precision training framework based on a multi-base logarithmic number system (LNS) and a multiplicative weight update algorithm. The LNS expresses a high dynamic range and computational energy efficiency, making it advantageous for on-board training in energy-constrained edge devices, for example. Compared to using a fixed-point number system for training with popular learning algorithms such as SGD and Adam, a multi-base LNS provides higher computational energy efficiency and improved prediction accuracy even when the precision of weight updates is substantially constrained. For example, utilizing 8-bits for forward propagation, 5-bits for activation gradients, and 16-bits for weight gradients, some embodiments may achieve comparable accuracy to full-precision state-of-the-art models such as ResNet-50 and BERT. In some cases an over 20× computational energy reduction may be achieved in the circuits applied for training, compared to 16 bit floating point precision training implementations.

The following description makes use of mathematical equations in places. It should be understood that these equations concisely depict various computational algorithms.

Embodiments of an end-to-end low-precision deep neural network (DNN) training system are disclosed that utilize low-precision updates and computation for forward propagation, backward propagation, and weight updates. The system utilizes a logarithmic number system (LNS) for improving computational energy efficiency, and a multiplicative weight update algorithm (herein, “LNS-Madam”) for updating weights directly in their logarithmic representation.

A multi-base LNS is utilized in which the log-base is powers of two. To further improve computational/energy efficiency, we an approximation algorithm is disclosed for conversion arithmetic in multi-base LNS. Any induced accuracy degradation is mitigated by learning of the approximation by the trained network, during training.

The disclosed additive approximation operates as a deterministic operation to layer-involved general matrix multiplications (GEMMs), and is thus intrinsically learned during training. The network weights are adapted based on approximated layer weights instead of original (unapproximated) layer weights. In other words, the network calculations intrinsically take into account the effect of the weight approximations and adjust the weights accordingly. This process may be recognized as a type of quantization-aware learning in which an additional quantization operation is associated with each (e.g., hidden) layer.

A quantization system is also disclosed herein for the proposed end-to-end low-precision training system. With a unified bitwidth setting of 8-bit for forward propagation, 5-bit for backward propagation, 16-bit for weight gradients and full-precision weight update, multi-base LNS may achieve comparable accuracy to full-precision state-of the- art models such as ResNet-50 and BERT.

Additionally, the precision of weight updates is constrained and comparisons demonstrated between LNS-Madam with stochastic gradient descent, and Adam, for weight update over a precision range from 16-bit to 10-bit. Results show that LNS-Madam always maintains a higher accuracy when precision is highly constrained. For the BERT model on SQuAD and GLUE benchmarks, the relative gaps between F-1 scores of LNS-Madam and Adam are larger than 20% when weight update is in 10-bit.

An exemplary energy efficiency analysis (Table 1) for multi-base LNS on various neural network models demonstrates that LNS achieves 20× energy reduction in the math datapath circuits compared to 16-bit floating-point (FP16) implementations.

TABLE 1

| | Multi-Base LNS | Fixed-Point | FP16 |
|---|---|---|---|
| Model | (mJ) | (mJ) | (mJ) |
| ResNet-18 | 0.5 | 0.23 | 3.34 |
| ResNet-50 | 0.18 | 0.42 | 6.15 |
| BERT-Large | 8.12 | 11.98 | 173.73 |

In the algorithm representations used herein, [symbol] (w) denotes the loss of a deep neural network (DNN), and the DNN itself is denoted by F(·W). The DNN comprises a number of layers L, the layers comprising adaptable weights denoted by W. The activation function across the layers is denoted by X.

A general algorithm for the forward propagation logic may then be expressed as

Xₗ=fₗ(Xₗ₋₁, Wₗ), ∀l∈[1, L]

The input vectors/signals to the DNN are denoted by X₀, and F(X, W)=X_{L}.

A general algorithm for the backpropagation logic to update activation values may be expressed as

$${∇}_{{X}_{l}} = \frac{\partial ( W )}{\partial {X}_{l}}$$

A general algorithm for the backpropagation logic to update weight values may be expressed as

$${∇}_{{W}_{l}} = \frac{\partial ℒ ( W )}{\partial {W}_{l}}$$

For the number system, β represents the bitwidth (number of bits to represent a value), x is any number, and x^{q} is the quantized value of the number x.

Techniques in accordance with the described embodiments utilize a multi-base logarithmic number system wherein the base is two (2) raised to a fractional exponent, such that

χ=sign×2^{\tilde{χ}/γ}, \tilde{χ}=0, 1, 2, . . . , 2^{β-1}−1

Here \tilde{χ} is an integer of bitwidth β−1 and γ is a base factor restricted to powers of two (2), such that γ=2^{b} where b is a non-negative integer. The base factor γ sets the distance between successive representable values within the number system.

Dot product operations are common during DNN training. Consider any two vectors a∈ [symbol] ⁿ and activation vector b∈ [symbol] ⁿ for a neural network, which are represented by their integer exponents ã and \tilde{b} in LNS. A dot product operation between them can be represented as follows:

$$\begin{matrix}{a}^{T} b = {\sum }_{i = 1}^{n} {sign}_{i} \times {2}^{\tilde{{a}_{i}} / γ} \times {2}^{\tilde{{b}_{i}} / γ} \\ = {\sum }_{i = 1}^{n} {sign}_{i} \times {2}^{( \tilde{{a}_{i}} + \tilde{{b}_{i}} / γ )} = {\sum }_{i = 1}^{n} {sign}_{i} \times {2}^{\tilde{{p}_{i}} / γ}\end{matrix} \qquad Equation 1$$

Here signᵢ=sign(aᵢ) ⊕sign(bᵢ). In this dot product operation, each element-wise multiplication is computed as an addition between integer exponents, which significantly improves the computational efficiency by utilizing adder circuits instead of multiplier circuits. However, the accumulation is difficult to compute efficiently as it involves first converting from logarithmic to linear format and then performing the addition operation. The conversion between these formats is computationally expensive as it involves computing 2^{\tilde{p}}^{ᵢ}^{/γ} using polynomial expansion. To mitigate the computational cost of the conversion, a hybrid method is utilized to approximate the conversion between logarithmic and linear number representation formats.

For a logarithmic number system, let \tilde{p}_{iq} and \tilde{p}ᵢᵣ be positive integers representing quotient and remainder, respectively, of the intermediate result \tilde{p}ᵢ/γ in Equation 1, and let υᵣ=2^{\tilde{p}}^{ᵢᵣ}^{/γ} . Therefore,

$$\begin{matrix}{2}^{\tilde{{p}_{i}} / γ} = {2}^{\tilde{{p}_{i}} / γ} = {2}^{\tilde{{p}_{iq}} + \tilde{{p}_{ir}} / γ} = {2}^{\tilde{{p}_{iq}}} \times {2}^{\tilde{{p}_{ir}} / γ} \\ = ( {v}_{r} << \tilde{{p}_{iq}} ) ,\end{matrix} \qquad Equation 2$$

Here «depicts a left bit-shifting computer instruction or operation. This transformation enables fast conversion by applying efficient bit-shifting over vᵣ whose value is bounded by the remainder. The different constant values of υᵣ=2^{\tilde{p}}^{ᵢᵣ}^{/γ} may be pre-computed and stored in a hardware or software look-up table (LUT), where the remainder \tilde{p}ᵢᵣ is used to select the constant for vᵣ. The quotient \tilde{p}_{iq} then determines how far to shift the constant. Because γ=2^{b}, the least significant bits (LSBs) of the exponent are the remainder, and the most significant bits (MSBs) are the quotient. As the size of the LUT grows, the computational overhead from conversion increases significantly in this approach. Typically, the LUT is required to contain 2^{b} entries for storing all possible values of v^{r}, which may be a prohibitive memory overhead for large values of b.

One solution for reducing the size of LUT is utilizing a Mitchell approximation algorithm:

υᵣ=2^{\tilde{p}}^{ᵢᵣ}²^{^{b}}=(1+\tilde{p}ᵢᵣ/2^{b})

When vᵣ is distant from zero or one, the approximation error induced by Mitchell approximation may be significant. To alleviate this error, the disclosed approximation techniques balance efficiency and approximation error. Specifically, pᵢᵣ is split into p_{irM} and p_{irL} to represent the MSB and LSB of the remainder, respectively. LSB values 2^{P}^{_{irL}} are approximated using Mitchell approximation, and MSB values [symbol] are pre-computed and stored using LUT, such that:

$${v}_{r} = {2}^{\tilde{{p}_{ir}} / {2}^{b}} = {2}^{\tilde{{p}_{ir} M} / {2}^{b}} \times {2}^{\tilde{{p}_{ir} L} / {2}^{b}} = ( 1 + \tilde{{p}_{ir}} / {2}^{b} ) \times {2}^{\tilde{{p}_{ir} M} / {2}^{b}} \qquad Equation 3$$

Here p_{irM} and p_{irL} represent bₘ MSB and b₁ LSB bits of pᵢᵣ. This reduces the size of LUT to 2^{b}^{ₘ} entries. For efficient hardware implementation of this algorithm, 2^{b}ₘ hardware registers may be utilized to accumulate different partial sum values and then multiply with constants from the LUT.

To enable reduced precision for values and arithmetic during training, a logarithmic quantization algorithm (LogQuant: [symbol] → [symbol] ) such as the following may be utilized:

$$Log Quant ( x , s , γ , β ) = sign ( x ) \times s \times {2}^{( \tilde{z} / ψ )} where \tilde{x} = clamp ( r o u n d ( {log}_{2} ( \vert x \vert / s ) x γ ) , 0 , {2}^{β - 1} - 1 ) \qquad Equation 4$$

The LogQuant algorithm quantizes a real number into an integer exponent with a limited number of bits. A scale factor s∈ [symbol] for each number in LNS maps the range of real values into the range of representable integer exponents. The LogQuant algorithm first brings scaled numbers |χ|/s into their logarithmic space, magnifies them by the base factor γ and then performs rounding and clamping functions to convert them into integer exponents \tilde{χ}.

The choice in a particular implementation of applied scale factors may have substantial impact on quantization error and neural network inference accuracy. A quantization system with an overabundance of scale factors may suffer decreased computational efficiency and increased memory utilization, while one with too few scale factors may suffer from increased quantization error. In the disclosed approaches, rather than computing a single scale factor over multiple dimensions of a tensor, a scale factor may be determined and applied for each vector of elements within a single dimension of a tensor. This per-vector scaling technique achieves lower quantization error without additional computational energy overhead. It may be especially beneficial for quantizing gradients where the distribution exhibits a wide range with high variance.

In one embodiment, quantization-aware training (QAT) is applied for quantizing weights and activations during forward propagation, where each quantizer is associated with a Straight Through Estimator (STE) to enable the gradient to directly flow through the non-differentiable quantizer during the backward pass. QAT treats each quantization function as an additional non-linear operation in the DNN. Therefore, the deterministic quantization error induced by any quantizer in the forward pass is implicitly mitigated through training. A weight quantization function Q_{W} and activation quantization function Q_{A} may be configured for each layer of the DNN during forward propagation according to:

Wₗ^{q}=Q_{w}(Wₗ, Xₗ^{q}=Q_{A}(fₗ(Xₗ₋₁, Wₗ^{q})

Some embodiments may utilize approximation-aware training (QAA), similar to QAT in many respects, that applies each conversion approximator as a non-linear operator. As a result, the approximation error in the forward pass may be similarly mitigated during training. Table 2 depicts exemplary results of the approximation utilized on various standard training sets for various sizes of LUT and a base factor γ=8. The approximated DNN network achieves low accuracy loss while substantially reducing the computational energy cost of training and operating the DNN for inference.

TABLE 2

| | LUT = 1 | LUT = 2 | LUT = 4 | LUT = 8 |
|---|---|---|---|---|
| CIFAR-10 | 92.58 | 92.54 | 92.68 | 93.43 |
| (Accuracy) | | | | |
| ImageNet | 75.80 | 75.85 | 75.94 | 76.05 |
| (Accuracy) | | | | |
| SQuAD | 87.57 | 87.11 | 88.00 | 87.82 |
| (F-1) | | | | |
| GLUE | 84.89 | 85.48 | 86.93 | 88.15 |
| (F-1) | | | | |
| Energy Cost | 12.29 | 14.71 | 17.24 | 19.02 |
| (fJ/op) | | | | |

In order to accelerate training, in addition to inference, gradients may be quantized into low-precision numbers. The distribution of gradients in many training models may resemble a Gaussian or log-normal distribution. Therefore, a logarithmic representation may more suitable than fixed-point representation when quantizing gradients. The activation gradients may be quantized using a quantization function Q_{E} and the weight gradients quantized using quantization function Q_{G}, for example according to the following algorithm:

∇_{X}_{ₗ}^{q}=Q_{E}(∇_{X}_{ₗ}), ∇_{W}_{ₗ}^{q}=Q_{G}(∇_{W}_{ₗ})

Table 3 below depicts benchmark results for various standard training sets and tasks. The table provides a benchmark comparison of multi-base LNS with fix-point and full-precision (FP32) number systems. The benchmarks utilize a unified bitwidth setting across tasks: 8-bit for weights Q_{W} and activations Q_{A}, 5-bit for activation gradients Q_{E}, and 16-bit for weight gradients Q_{G}, with an approximated LNS using LUT=4 for all cases. On SQuAD datasets, a relatively large performance gap is evident between LNS and fixed-point number system implementations because the fixed-point number system requires a larger bitwidth of Q_{E}.

Table 3 shows results on various tasks and datasets where the weight update in performed in full-precision. Utilizing 8-bit precision for both weights and activations, 16-bit precision for weight gradients, and 5-bit precision for activation gradients consistently demonstrates almost no loss or degradation. Multi-base LNS consistently outperforms fixed-point number system and achieves accuracy comparable to the full-precision counterpart.

TABLE 3

| | | Multi-Base LNS | | Fixed- | Full- |
|---|---|---|---|---|---|
| Dataset | Task | Standard | Approximated | Point | Precision |
| CIFAR-10 | ResNet-18 | 93.43 | 92.68 | 93.31 | 93.51 |
| ImageNet | ResNet-50 | 76.05 | 75.85 | 73.86 | 76.38 |
| SQuAD | BERT-base | 87.82 | 88.00 | 24.7 | 88.36 |
| SQuAD | BERT-large | 90.38 | 90.41 | 16.5 | 90.80 |
| GLUE | BERT-base | 88.15 | 86.86 | 81.18 | 88.92 |
| GLUE | BERT-large | 89.24 | 86.93 | 87.97 | 89.35 |

The effects of low-precision weight updates under LNS are complex. The introduction, the precision of the weights for the update significantly affects the quality of training. A generalized form of a full-precision weight update may be expressed as:

Wₜ₊₁=U(Wₜ, ∇_{W}_{ₜ}^{q})

Here U represents any learning algorithm. For example, the gradient descent (GD) weight update algorithm takes the form

U_{GD}=Wₜ−η∇_{W}_{ₜ}^{q}

where η is a pre-defined parameter that controls the rate of learning.

A low precision weight update may be expressed as follows:

Wₜ₋₁^{U}=Q_{U}(U(Wₜ^{U}, ∇_{W}_{ₜ}^{q})) Equation 5

Here Q_{U} is a quantization function for the updated weights. The value W^{U} may be directly stored in a low-precision format. Assume U to be a full-precision function for simplicity. The value for U may be computed using low-precision arithmetic and storing its intermediate results, such as first-order moment estimation, in low-precision.

A two-stage quantization may be utilized for weight values. In forward and backward propagation, a relatively small bitwidth β_{W} may be configured for weights to compute the typically very large number of general matrix multiplications (GEMMs) efficiently. During weight update, a relatively larger (compared to β_{W}) bitwidth β_{U} may be utilized due to the precision required for accumulating updates. Utilizing two-stage quantization for weights may be practically equivalent to using a single-stage weight quantization with additional high precision gradient accumulators, although using gradient accumulators may involve fewer hardware resources in some cases.

Quantization error is induced by Q_{U}. As the quantization error decreases, the mismatch between the updated weights and their representable counterparts becomes smaller. This quantization error depends on not only Q_{U} but also the interaction between the quantization Q_{U} and the learning algorithm U.

The following description applies to a multi-base LNS low-precision framework where Q_{U}=LogQuant. First, consider the classical gradient descent (GD) algorithm U_{GD}. Its corresponding LNS-based low-precision weight update algorithm is:

Wₜ₊₁=LogQuant(Wₜ−η_{W}_{ₜ}^{q})

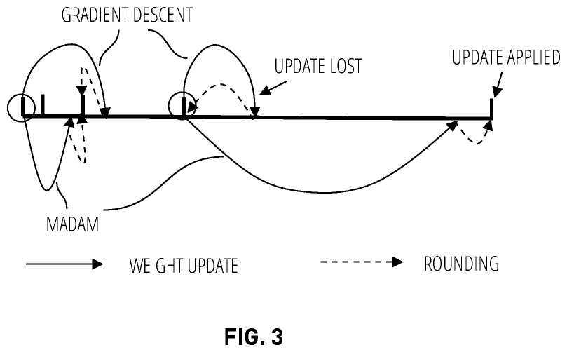

This algorithm updates the weights using ∇_{W}_{ₜ}^{q} with η irrespective of weight magnitudes. However, the representation gaps, which are the distances between successive discretization levels, become larger in LNS as the weights move away from zero. This exacerbates the mismatches between the updates generated by GD and the representation gaps in LNS. As a result, the updates η∇_{W}_{ₜ} may be orders of magnitude smaller than the corresponding representation gaps, as depicted previously in FIG. 3. In other words, the quantization errors induced by LogQuant and GD are magnified when the weights become larger. This mismatch frequently occurs because the updates generated by GD are not proportional to the weight magnitudes. To alleviate this mismatch problem, a new multiplicative learning algorithm LNS-Madam may be utilized. An embodiment algorithm for LNS-Madam is provided in the CODE LISTINGS.

The conventional Madam optimizer updates the weights multiplicatively using normalized gradients:

$${U}_{M a d a m} = {W}_{t} ⊙ {e}^{- η sign ( {W}_{t} ) ⊙ {g}_{t}^{*}} , {g}_{t}^{*} = {g}_{t} / \sqrt{} \qquad Equation 6$$

Here ⊙ denotes element-wise multiplication, g represents the full-precision gradient ∇_{W}, and g* is the normalized gradient. The normalized gradient g* is the fraction between the gradient g and square root of its second moment estimate

$$\sqrt{}$$

Because of its multiplicative property, the Madam algorithm naturally generates updates proportional to the size of the weights. LNS-Madam is modified variant of Madam tailored to a multi-base LNS:

$${U}_{L N S - M a d a m} = sign ( {W}_{t} ) ⊙ {2}^{{W}_{t / γ} - η sign ( {W}_{t} ) ⊙ {g}_{t}^{*}} , \\ {g}_{t}^{*} = / \sqrt{} \qquad Equation 7$$

In LNS-Madam, the log-base is changed from the natural logarithm e to two (2) to provide mitigation of the weight size influence by enabling selection of different learning rates η. The gradient is also changed to the first-order gradient estimate [symbol] to produce a variance-reduced normalized gradient. The base factor y may be configured to tune the LNS and LNS-Madam algorithms jointly. By representing Equation 7 in logarithmic space, LNS-Madam may be seen to directly optimize (in the sense of making the algorithm more accurate and efficient) integer exponents of the weights stored in multi-base LNS:

\tilde{W}ₜ₊₁=\tilde{W}ₜ−ηsign(Wₜ)⊙gₜ* Equation 8

Additionally, considering the low-precision weight update, LogQuant quantizes the updated weights by applying round and clamp functions on \tilde{W}ₜ₊₁ directly, without a conversion between linear and logarithmic space. As shown in Equation 8, base factor γ couples the learning algorithm and the logarithmic representation. The base factor not only sets the precision of the representation but provides an underlying strength determining how far each weight may change due to an update.

In one embodiment multi-base LNS may be implemented using a Pytorch-based neural network quantization library that implements a set of common neural network layers (e.g., convolution, fully-connected) for training and inference in both full and quantized modes. The library support for integer quantization in a fixed-point number system may be extended in accordance with the embodiments described herein to support a logarithmic number system. The library also provides utilities for scaling values to the representable integer range of the specific number format. With this library, a typical quantized layer comprises a conventional layer implemented in floating-point preceded by a weight quantizer and an input quantizer that convert the weights and inputs of the layer to the desired quantized format. For the backward pass, after the gradients pass through the STE in each quantizer, values are also quantized by LogQuant.

Quantization may be applied to the DNN weights W, activations X, weight gradients ∇_{W} and activation gradients ∇_{X}. An effective number system should have a bitwidth setting that works across different applications. Therefore a uniform configuration for the bitwidth may be utilized. For example an 8-8-5-16 configuration may be utilized, representing the bitwidth of Q_{W}, Q_{A}, Q_{E}, and Q_{G}, respectively. The setting of base factors for multi-base LNS may in one embodiment be set as: γ=8 for Q_{W} and Q_{A}, and γ=1 for Q_{E} and Q_{G}.

In one embodiment the approximators are applied only to the forward propagation to enable approximation-aware training. After training, an approximated model may be deployed for faster, more efficient inference. With base factor γ=8, the approximation setting from LUT=1 to LUT=8 may be evaluated. As shown in Table 2, conversion approximation does not incur an unacceptable accuracy degradation for many practical applications.

To benchmark LNS-Madam, consider low-precision weight updates by applying Q_{U}=LogQuant on the updated weights at each update iteration, utilizing multi-base LNS as the underlying number system and implementing the same bitwidth configurations for Q_{W}, Q_{A}, Q_{E}, and Q_{G} as described above. Conversion approximation is not applied in this benchmark, which compares LNS-Madam on various datasets with conventional optimizers. BERT-base is used as the evaluation set for SQuAD and GLUE benchmarks. For LNS-Madam, the learning rate η is represented as powers of two (2) to accommodate the base factor setting. The value of η is tuned from 2⁻⁴ to 2⁻¹⁰ and the η with superior outcomes is selected for each task. Multiplicative learning algorithms may utilize an initialization different from the conventional one. Therefore, for the ImageNet benchmark, a stochastic gradient descent (SGD) is applied as a “warm-up” gradient algorithm for the first 10 epochs to mitigate this initialization issue. The bitwidth of Q_{U} is varied from 16-bit to 10-bit to test LNS-Madam's performance on a range of bitwidth settings. To maintain the dynamic range of Q_{U} the same as the range of Q_{W}, the base factor γ is increased as bitwidth becomes larger. For example, 16-bit Q_{U} is associated with a base factor γ=2048. LNS-Madam in these benchmarks consistently provides a higher accuracy than conventional optimizers when precision is constrained at the low end. For the BERT model on SQuAD and GLUE benchmarks, the relative gaps between F-1 scores of LNS-Madam and Adam are larger than 20% when weight update is in 10-bit.

Generally, improvements in neural network energy utilization may be obtained by applying a multi-base logarithmic number system to update weights of the neural network during training, in low precision, and by applying a multiplicative update to the weights in a logarithmic representation. This may generally involve computing a ratio of estimated first and second order moments of the weight gradients. The quantization utilized in this process may generally involve forming a ratio of a precision bitwidth and a logarithmic base factor, and applying the ratio as the exponent of a power of two. A similar ratio may be utilized as the exponent of a power of two log base that varies between weight updates, backpropagation, and feed-forward computations in the neural network. Generally, a small (<10 entries) lookup table may be utilized with left shift operations to approximate additions in the multi-base logarithmic number system during weight updates.

The feedback (e.g., backpropagation), the feed-forward signals (e.g., activations), and the weight updates for the training may all be computed in low-precision relative to conventional 16 and 32 bit floating point calculations for training.

The following description may be best understood with reference to certain terminology as follows.

“Backpropagation” refers to an algorithm used in neural networks to calculate a gradient for updating the weights in the neural network. Backpropagation algorithms are commonly used to train neural networks. In backpropagation a loss function calculates a difference between the actual outputs of the neural network and expected outputs of the neural network.

“Bias addition” refers to inclusion of a bias (e.g., a fixed output value or increment to an output value) for one or more neurons of a neural network layer. Bias addition is a technique for ensuring that at least one neuron of a layer produces a non-zero activation to a next layer when the layer does not detect any features in its inputs.

“Buffer” refers to a memory storing values that are inputs to or results from a calculation.

“Controller” refers to any logic to control the operation of other logic. When a controller is implemented in hardware, it may for example be one of many well-known models of microprocessor, graphics processing unit, or a custom controller implemented using an application-specific integrated circuit (ASIC), a system-on-a-chip (SOC), or in many other manners known in the art. A controller may also be implemented in software or firmware, as computer instructions stored in a volatile memory or a non-volatile memory. Controllers are typically used to coordinate the operation of one or more other components in a system, for example providing signals to the other components to start and stop their operation, or to instruct the other components with particular commands to carry out. Generally, if the specific algorithm for a controller is not specified herein, it should be understood to mean that the logic to perform the controller functions would be readily understood and implemented (e.g., via programming code/instructions) by a person of ordinary skill in the art.

“Deep neural network” refers to a neural network with one or more hidden layers.

“Dot-product-accumulate” refers to the computation of a dot product. A dot product is the sum of the products of the corresponding entries of the two sequences (vectors) of numbers. Dot products are efficiently computed using vector multiply-accumulate units.

“Edge device” refers to a network-coupled device located on a terminal leaf node of the network.

“Fully-connected layer” refers to a layer of the in which each of the neurons have connections to all activations in the previous layer.

“Global memory buffer” refers to a buffer available for utilization by all or at least a plurality of processing elements on a chip.

“Input activation” refers to an activation received by a neuron in a neural network.

“Input layer” refers to the first layer of a neural network that receives the input values to analyze and classify.

“Loss function” refers to also referred to as the cost function or error function (not to be confused with the Gauss error function), is a function that maps values of one or more variables onto a real number intuitively representing some “cost” associated with those values.

“Low-precision” generally refers to any computational precision less than 16-bit or 32 bit floating precision as utilized in conventional neural network training.

“Multicast” refers to a group communication mechanism whereby transmission of data is addressed to a group of destination devices (e.g., processing elements) simultaneously. Multicast can implement one-to-many or many-to-many distribution.

“Multiply-accumulate unit” refers to a data processing circuit that carries out multiply-accumulate operations, which involve computing the product of two numbers and adding that product to an accumulator. Multiply-accumulate units may be referred to herein by their acronym, MAC or MAC unit. A multiply-accumulate unit carries out computations of the form a<−a+(b*c). A vector multiply-accumulate unit computes the product of two vectors using an array of multipliers, then performs a reduction operation by adding all the outputs of multipliers to produce a partial sum, which is then added to an accumulator.

“Output activation” refers to an activation output by a neuron in a neural network. An output activation is typically computed based on the input activations to the neuron and the weights applied to the input activations.

“Output layer” refers to the final layer of a neural network that generates the classification(s) of the values applied to the input layer.

“Partial sum” refers to an intermediate multiply-accumulate result in a dot-product-accumulate calculation.

“Post-processor” refers to logic in a neural network calculation applied after multiplication and accumulation.

“Weights” refers to values with which activations are multiplied to increase or decrease the impact of the activation values in an activation function.

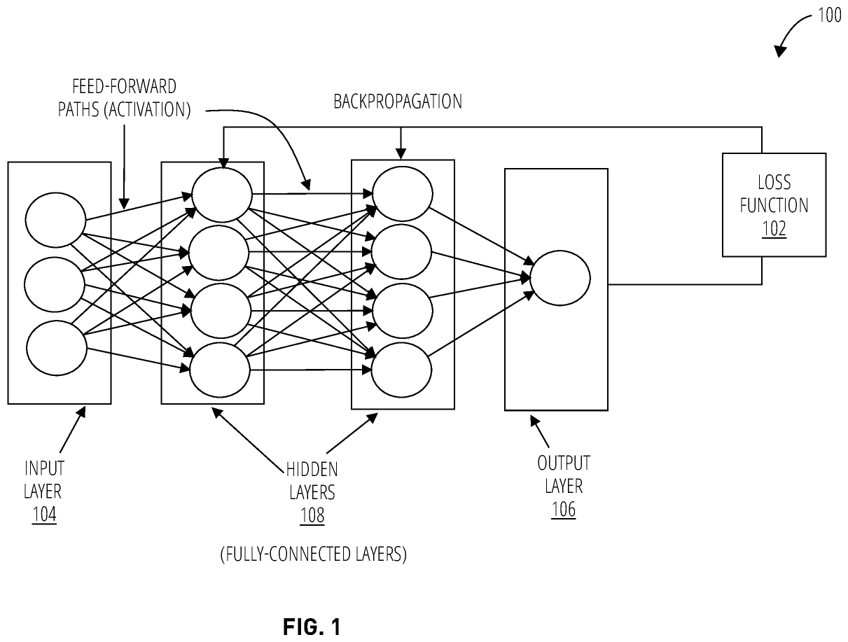

FIG. 1 depicts a basic deep neural network 100 (DNN) comprising a collection of connected units or nodes called artificial neurons, organized into layers. Each coupling between layers may transmit a signal from one artificial neuron to another. An artificial neuron in an internal (hidden) layer that receives a signal processes it and then signals additional artificial neurons connected to it.

In common implementations, the signal at a coupling between artificial neurons is a real number, and the output of each artificial neuron is computed by some non-linear function (the activation function) of the sum of its inputs. The couplings between artificial neurons are called ‘edges’ or axons. Artificial neurons and edges typically have a weight that adjusts as learning proceeds. The weight increases or decreases the strength of the signal at a connection. The weights are evolved according to a loss function 102 that is utilized during training of the network. The activation function (e.g., threshold for activation) may in some cases also evolve according to the loss function 102 during learning. Artificial neurons may have a threshold (trigger threshold) such that the signal is only sent if the aggregate received signal crosses that threshold.

Typically, artificial neurons are arranged into layers. Different layers may perform different kinds of transformations on their inputs into activations. Signals travel from the first layer (the input layer 104), to the last layer (the output layer 106), possibly after traversing one or more intermediate layers, called hidden layers 108.

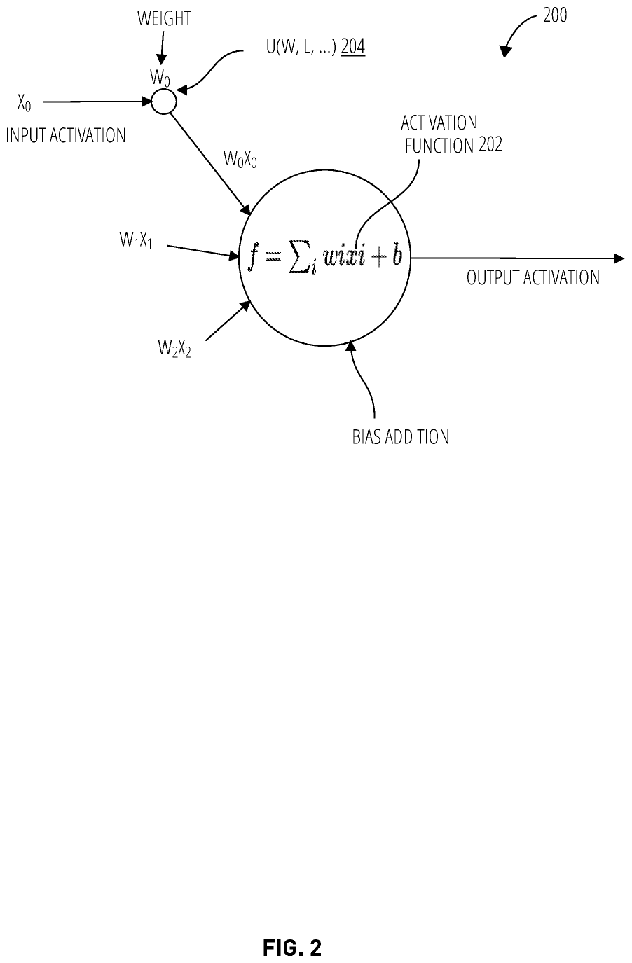

Referring to FIG. 2, an artificial neuron 200 receiving inputs from predecessor neurons consists of the following components:
inputs xᵢ;
weights wᵢ applied to the inputs;
an optional threshold (b), which may be evolved by a learning function; and
an activation function 202 that computes the output from the previous neuron inputs and threshold, if any.

An input neuron has no predecessor but serves as input interface for the whole network. Similarly an output neuron has no successor and thus serves as output interface of the whole network.

The network includes connections, each connection transferring the output of a neuron in one layer to the input of a neuron in a next layer. Each connection carries an input x and is assigned a weight w. For inputs from prior layers, the input x is referred to as an activation.

The activation function 202 often has the form of a sum of products of the weighted values of the inputs of the predecessor neurons.

A learning rule is a rule or an algorithm which modifies the parameters of the neural network, in order for a given input to the network to produce a favored output. The learning process typically involves modifying the weights (according to a weight update function 204) and sometimes also the thresholds (according to an update of the activation function 202) of the neurons and connections within the network.

FIG. 3 depicts a comparison of updating weights using Gradient Descent (GD) and Madam under logarithmic representation. Each coordinate (heavy vertical line) represents a number stored in LNS. Assume the weights at two circles receive the same gradient. The updates generated from GD are disregarded as the weights move larger, whereas the updates generated by Madam are adjusted with the weights.

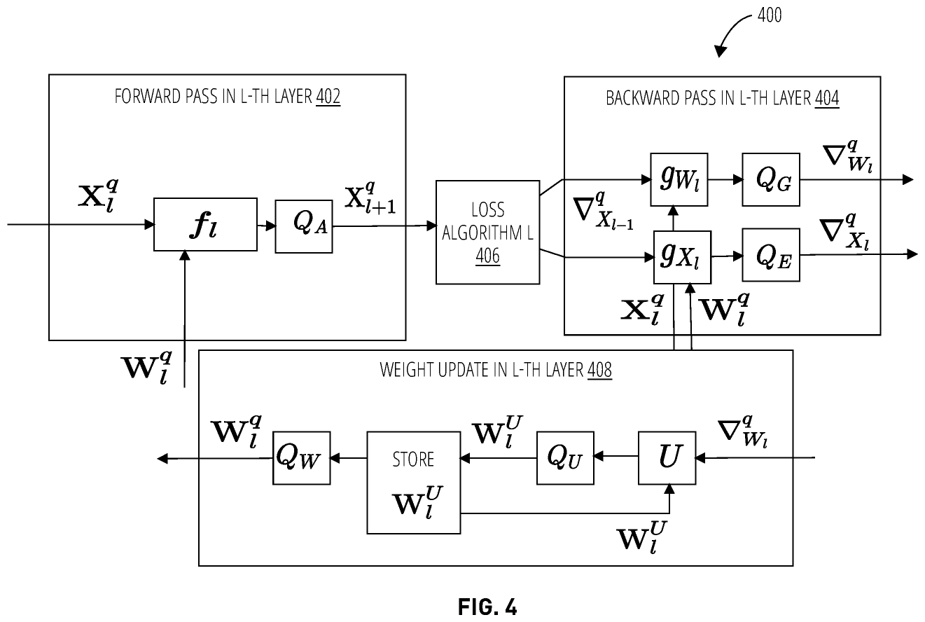

FIG. 4 depicts a DNN training algorithm data flow 400 and end-to-end low-precision training system in one embodiment. In the training algorithm data flow 400, all operands (weight and activation updates, gradients etc.) are low-precision.

The training algorithm data flow 400 is depicted for the forward pass 402, the backward pass 404, loss algorithm L 406, and the weight update 408 for the L-th layer, with low-precision values flowing through the system.

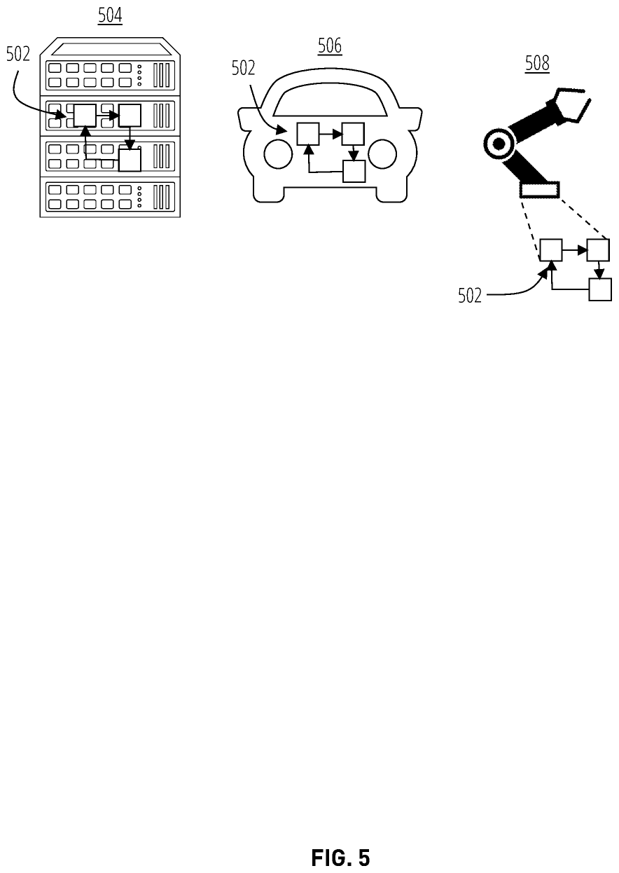

FIG. 5 depicts exemplary scenarios for use of a neural network training and inference system 502 in common commercial applications. A neural network training and inference system 502 may be utilized in a computing system 504, a vehicle 506, and a robot 508, to name just a few examples.

One common implementation of neural network training and inference systems is in data centers. For example many Software as a Service (SaaS) systems utilize neural network training and/or inference hosted in a data center.

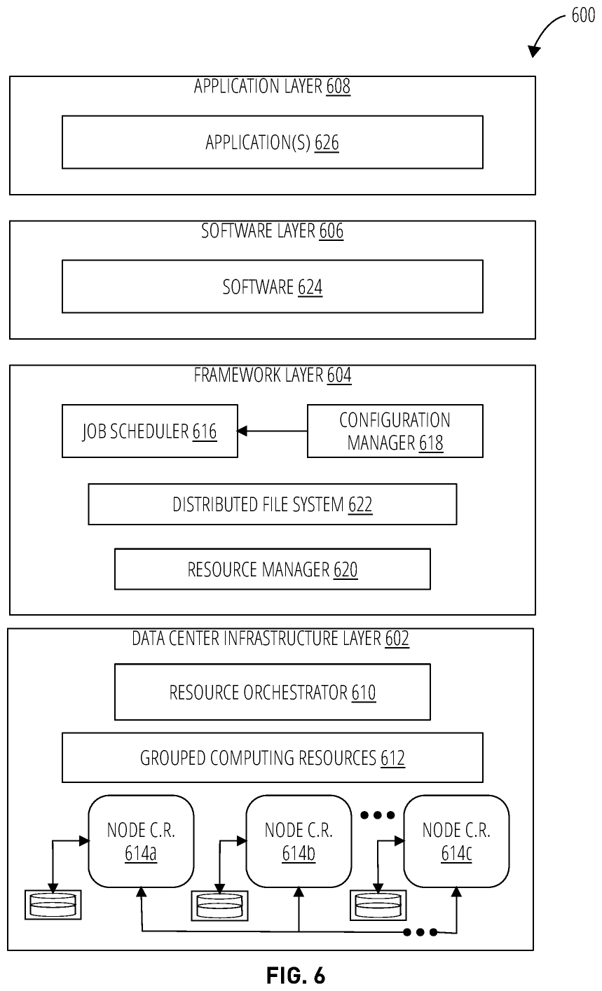

FIG. 6 depicts an exemplary data center 600 in one embodiment that may be configured to carry out aspects of the neural network training techniques described herein. In at least one embodiment, data center 600 includes, without limitation, a data center infrastructure layer 602, a framework layer 604, software layer 606, and an application layer 608.

In at least one embodiment, as depicted in FIG. 6, data center infrastructure layer 602 may include a resource orchestrator 610, grouped computing resources 612, and node computing resources (“node C.R.s”) Node C.R. 614a, Node C.R. 614b, Node C.R. 614c, . . . node C.R. N), where “N” represents any whole, positive integer. In at least one embodiment, node C.R.s may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s may be a server having one or more of above-mentioned computing resources. For example ne or more of the node computing resources may comprise one or more neural network training and inference system 502, neural network processor 700, processing element 800, and/or parallel processing unit 902, configured with logic to carry out embodiments of the neural network training techniques disclosed herein.

In at least one embodiment, grouped computing resources 612 may include separate groupings of node C.R.s housed within one or more racks (not shown), or many racks housed in data centers at various geographical locations (also not shown). Separate groupings of node C.R.s within grouped computing resources 612 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 610 may configure or otherwise control one or more node C.R.s and/or grouped computing resources 612. In at least one embodiment, resource orchestrator 610 may include a software design infrastructure (“SDI”) management entity for data center 600. In at least one embodiment, resource orchestrator 610 may include hardware, software or some combination thereof.

In at least one embodiment, as depicted in FIG. 6, framework layer 604 includes, without limitation, a job scheduler 616, a configuration manager 618, a resource manager 620, and a distributed file system 622. In at least one embodiment, framework layer 604 may include a framework to support software 624 of software layer 606 and/or one or more application(s) 626 of application layer 220. In at least one embodiment, software 624 or application(s) 626 may respectively include web-based service software or applications, such as those provided by Amazon Web Services, Google Cloud and Microsoft Azure. In at least one embodiment, framework layer 604 may be, but is not limited to, a type of free and open-source software web application framework such as Apache Spark™ (hereinafter “Spark”) that may utilize a distributed file system 622 for large-scale data processing (e.g., “big data”). In at least one embodiment, job scheduler 616 may include a Spark driver to facilitate scheduling of workloads supported by various layers of data center 600. In at least one embodiment, configuration manager 618 may be capable of configuring different layers such as software layer 606 and framework layer 604, including Spark and distributed file system 622 for supporting large-scale data processing. In at least one embodiment, resource manager 620 may be capable of managing clustered or grouped computing resources mapped to or allocated for support of distributed file system 622 and distributed file system 622. In at least one embodiment, clustered or grouped computing resources may include grouped computing resources 612 at data center infrastructure layer 602. In at least one embodiment, resource manager 620 may coordinate with resource orchestrator 610 to manage these mapped or allocated computing resources.

In at least one embodiment, software 624 included in software layer 606 may include software used by at least portions of node C.R.s, grouped computing resources 612, and/or distributed file system 622 of framework layer 604. One or more types of software may include, but are not limited to, Internet web page search software, e-mail virus scan software, database software, and streaming video content software.

In at least one embodiment, application(s) 626 included in application layer 608 may include one or more types of applications used by at least portions of node C.R.s, grouped computing resources 612, and/or distributed file system 622 of framework layer 604. In at least one or more types of applications may include, without limitation, CUDA applications, 5G network applications, artificial intelligence application, data center applications, and/or variations thereof.

In at least one embodiment, any of configuration manager 618, resource manager 620, and resource orchestrator 610 may implement any number and type of self-modifying actions based on any amount and type of data acquired in any technically feasible fashion. In at least one embodiment, self-modifying actions may relieve a data center operator of data center 600 from making possibly bad configuration decisions and possibly avoiding underutilized and/or poor performing portions of a data center.

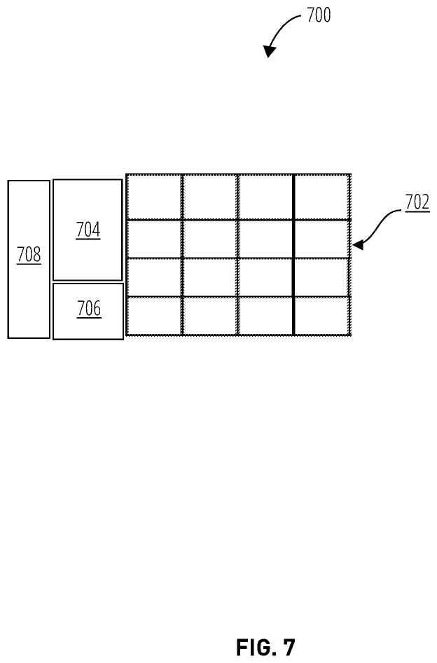

FIG. 7 depicts a neural network processor 700 in one embodiment that may include or be configured with logic to carry out the neural network training techniques disclosed herein. The neural network processor 700 carries out a computational flow (e.g., for training and/or inference) between a plurality of processing elements 702. The neural network processor 700 also comprises a global buffer 704 and controller 706, which for example may be a RISC-V processor. The processing elements 702 communicate with one another and with the global buffer 704 via the router 708 or other interconnect technology (see the GPU implementations, described further below). The router 708 may be implemented centrally or in distributed fashion as routers on each of the processing elements 702.

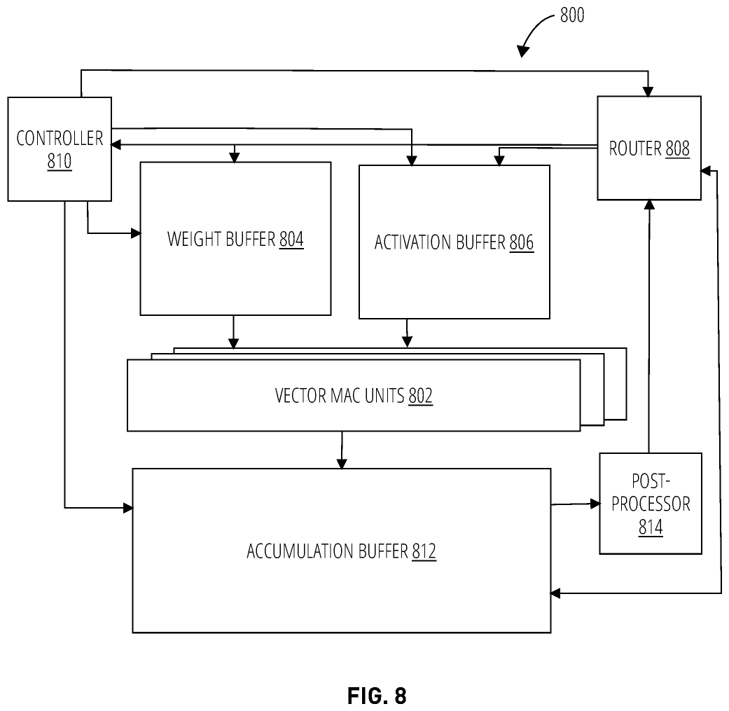

FIG. 8 depicts, and a high level, an exemplary processing element 800. The processing element 800 includes a plurality of vector multiply-accumulate units 802, a weight buffer 804, an activation buffer 806, a router 808, a controller 810, an accumulation memory buffer 812, and a post-processor 814. The activation buffer 806 may, in one embodiment, be implemented as a dual-ported SRAM to receive activation values from the global buffer 704 or from other local or global processing elements, via the router 808 or other interconnect. The router 808 may be a component of a distributed router 708 that in one embodiment comprises a serializer/de-serializer, packetizer, arbitrator, Advanced eXtensible Interface, and other components known in the art.

The weight buffer 804 may, in one embodiment, be implemented as a single-ported SRAM storing weigh values. The weight values used by the vector multiply-accumulate units 802 may be “weight-stationary”, meaning they are not updated each clock cycle, but instead are updated only after the output activation values are computed for a particular layer of a deep neural network.

The accumulation memory buffer 812 may comprise one or more SRAM devices to store the output activations computed by the vector multiply-accumulate units 802. The router 808 communicates these output activations and control signals from the processing element 800 to other processing elements. “Output activation” refers to an activation output by a neuron in a neural network. An output activation is typically computed based on the input activations to the neuron and the weights applied to the input activations. “Input activation” refers to an activation received by a neuron in a neural network.

The processing element 800 may perform operations of convolutional and fully-connected layers of a DNN efficiently, including multiply-accumulate, truncation, scaling, bias addition, ReLU, and pooling (these last five in the post-processor 814, which may comprise one or more of weight update, activation calculation/update, and/or gradient calculation logic utilizing the low-precision computational techniques described herein). The vector multiply-accumulate units 802 may operate on the same inputs using different filters. In one embodiment, each of the vector multiply-accumulate units 802 performs an eight-input-channel dot product and accumulates the result into the accumulation memory buffer 812 on each clock cycle. The weights stored in the weight buffer 804 are unchanged until the entire computation of output activations completes. Each processing element 800 reads the input activations in the activation buffer 806, performs the multiply-accumulate operations, and writes output activations to the accumulation memory buffer 812 on every clock cycle. The frequency at which the weight buffer 804 is accessed depends on the input activation matrix dimensions and the number of filters utilized.

The vector multiply-accumulate units 802 of each processing element 800 computes a portion of a wide dot-product-accumulate as a partial result and forwards the partial result to neighboring processing elements. “Dot-product-accumulate” refers to the computation of a dot product. A dot product is the sum of the products of the corresponding entries of the two sequences (vectors) of numbers. Dot products are efficiently computed using vector multiply-accumulate units. “Multiply-accumulate unit” refers to a data processing circuit that carries out multiply-accumulate operations, which involve computing the product of two numbers and adding that product to an accumulator. Multiply-accumulate units may be referred to herein by their acronym, MAC or MAC unit. A multiply-accumulate unit carries out computations of the form a<−a+(b*c). A vector multiply-accumulate unit computes the product of two vectors using an array of multipliers, then performs a reduction operation by adding all the outputs of multipliers to produce a partial sum, which is then added to an accumulator.

The partial results are transformed into a final result by the post-processor 814 and communicated to the global buffer 704. The global buffer 704 acts as a staging area for the final multiply-accumulate results between layers of the deep neural network.

The accumulation memory buffer 812 receives outputs from the vector multiply-accumulate units 802. The central controller 706 distributes the weight values and activation values among the processing elements and utilizes the global memory buffer as a second-level buffer for the activation values. When processing images, the controller 706 configures processing by layers of the deep neural network spatially across the processing elements by input/output channel dimensions and temporally by image height/width.

The global buffer 704 stores both input activations and output activations from the processing elements 702 for distribution by the aforementioned transceivers to the processing elements via, for example, multicast. “Multicast” refers to a group communication mechanism whereby transmission of data is addressed to a group of destination devices (e.g., processing elements) simultaneously. Multicast can implement one-to-many or many-to-many distribution. Some or all of the processing elements 702 include a router 808 to communicate, in one embodiment, 64 bits of data in, and 64 bits of data out, per clock cycle. This enables accumulation of partial sums for wide dot products that have their computation spatially tiled across the processing elements 702.

The algorithms and techniques disclosed herein may be executed by computing devices utilizing one or more graphic processing unit (GPU) and/or general purpose data processor (e.g., a 'central processing unit or CPU). For example the controller 706, controller 810, or a more general computing platform may include one or more GPU/CPU for implementing the disclosed algorithms and techniques. In some cases the algorithms or parts of the algorithms may be implemented as instruction set architecture instructions/extensions in hardware circuits, and/or as micro-coded instructions. Exemplary architectures will now be described that may be configured to carry out the techniques disclosed herein on such devices.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

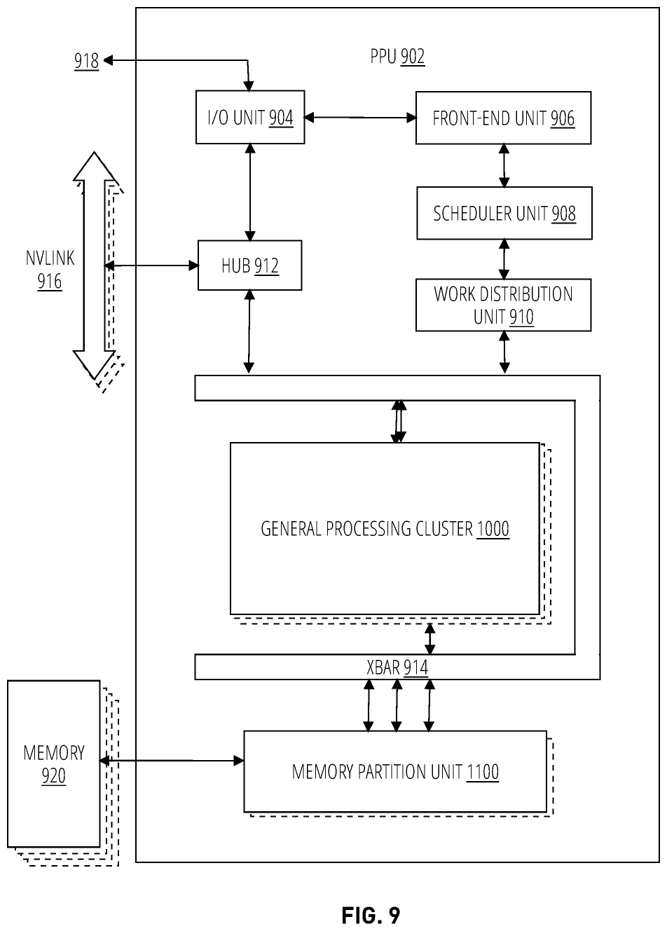

FIG. 9 depicts a parallel processing unit 902, in accordance with an embodiment. In an embodiment, the parallel processing unit 902 is a multi-threaded processor that is implemented on one or more integrated circuit devices. The parallel processing unit 902 is a latency hiding architecture designed to process many threads in parallel. A thread (e.g., a thread of execution) is an instantiation of a set of instructions configured to be executed by the parallel processing unit 902. In an embodiment, the parallel processing unit 902 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 902 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 902 modules may be configured to accelerate thousands of High Performance Computing (HPC), data center, and machine learning applications. The parallel processing unit 902 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 9, the parallel processing unit 902 includes an I/O unit 904, a front-end unit 906, a scheduler unit 908, a work distribution unit 910, a hub 912, a crossbar 914, one or more general processing cluster 1000 modules, and one or more memory partition unit 1100 modules. The parallel processing unit 902 may be connected to a host processor or other parallel processing unit 902 modules via one or more high-speed NVLink 916 interconnects. The parallel processing unit 902 may be connected to a host processor or other peripheral devices via an interconnect 918. The parallel processing unit 902 may also be connected to a local memory comprising a number of memory 920 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 920 may comprise logic to configure the parallel processing unit 902 to carry out aspects of the techniques disclosed herein.

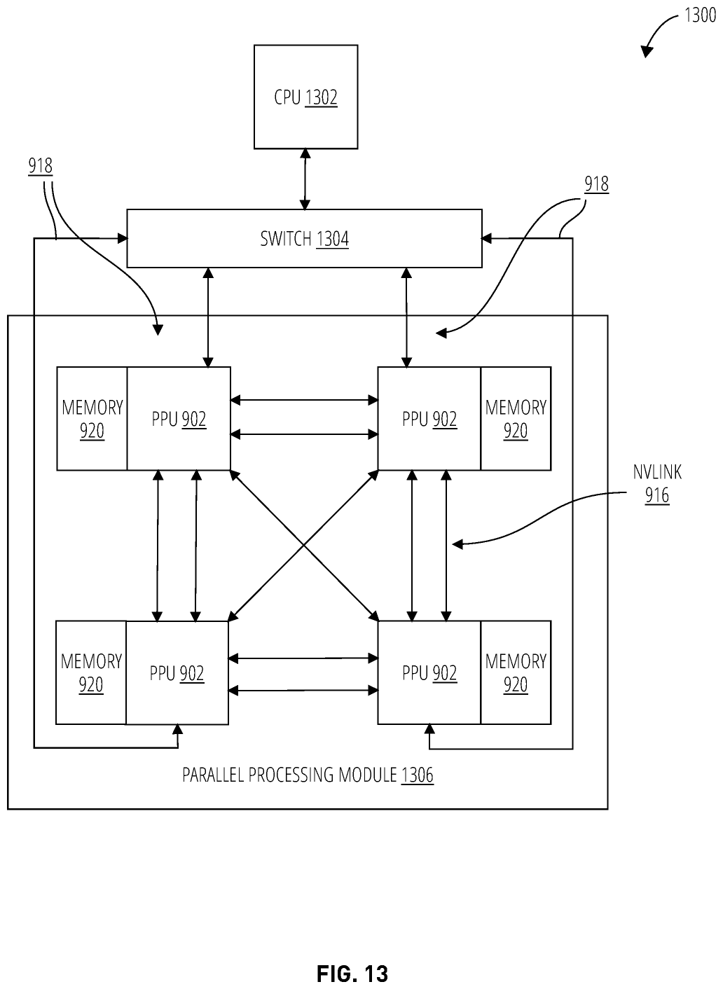

The NVLink 916 interconnect enables systems to scale and include one or more parallel processing unit 902 modules combined with one or more CPUs, supports cache coherence between the parallel processing unit 902 modules and CPUs, and CPU mastering. Data and/or commands may be transmitted by the NVLink 916 through the hub 912 to/from other units of the parallel processing unit 902 such as one or more copy engines, a video encoder, a video decoder, a power management unit, etc. (not explicitly shown). The NVLink 916 is described in more detail in conjunction with FIG. 13.

The I/O unit 904 is configured to transmit and receive communications (e.g., commands, data, etc.) from a host processor (not shown) over the interconnect 918. The I/O unit 904 may communicate with the host processor directly via the interconnect 918 or through one or more intermediate devices such as a memory bridge. In an embodiment, the I/O unit 904 may communicate with one or more other processors, such as one or more parallel processing unit 902 modules via the interconnect 918. In an embodiment, the I/O unit 904 implements a Peripheral Component Interconnect Express (PCIe) interface for communications over a PCIe bus and the interconnect 918 is a PCIe bus. In alternative embodiments, the I/O unit 904 may implement other types of well-known interfaces for communicating with external devices.

The I/O unit 904 decodes packets received via the interconnect 918. In an embodiment, the packets represent commands configured to cause the parallel processing unit 902 to perform various operations. The I/O unit 904 transmits the decoded commands to various other units of the parallel processing unit 902 as the commands may specify. For example, some commands may be transmitted to the front-end unit 906. Other commands may be transmitted to the hub 912 or other units of the parallel processing unit 902 such as one or more copy engines, a video encoder, a video decoder, a power management unit, etc. (not explicitly shown). In other words, the I/O unit 904 is configured to route communications between and among the various logical units of the parallel processing unit 902.

In an embodiment, a program executed by the host processor encodes a command stream in a buffer that provides workloads to the parallel processing unit 902 for processing. A workload may comprise several instructions and data to be processed by those instructions. The buffer is a region in a memory that is accessible (e.g., read/write) by both the host processor and the parallel processing unit 902. For example, the I/O unit 904 may be configured to access the buffer in a system memory connected to the interconnect 918 via memory requests transmitted over the interconnect 918. In an embodiment, the host processor writes the command stream to the buffer and then transmits a pointer to the start of the command stream to the parallel processing unit 902. The front-end unit 906 receives pointers to one or more command streams. The front-end unit 906 manages the one or more streams, reading commands from the streams and forwarding commands to the various units of the parallel processing unit 902.

The front-end unit 906 is coupled to a scheduler unit 908 that configures the various general processing cluster 1000 modules to process tasks defined by the one or more streams. The scheduler unit 908 is configured to track state information related to the various tasks managed by the scheduler unit 908. The state may indicate which general processing cluster 1000 a task is assigned to, whether the task is active or inactive, a priority level associated with the task, and so forth. The scheduler unit 908 manages the execution of a plurality of tasks on the one or more general processing cluster 1000 modules.

The scheduler unit 908 is coupled to a work distribution unit 910 that is configured to dispatch tasks for execution on the general processing cluster 1000 modules. The work distribution unit 910 may track a number of scheduled tasks received from the scheduler unit 908. In an embodiment, the work distribution unit 910 manages a pending task pool and an active task pool for each of the general processing cluster 1000 modules. The pending task pool may comprise a number of slots (e.g., 32 slots) that contain tasks assigned to be processed by a particular general processing cluster 1000. The active task pool may comprise a number of slots (e.g., 4 slots) for tasks that are actively being processed by the general processing cluster 1000 modules. As a general processing cluster 1000 finishes the execution of a task, that task is evicted from the active task pool for the general processing cluster 1000 and one of the other tasks from the pending task pool is selected and scheduled for execution on the general processing cluster 1000. If an active task has been idle on the general processing cluster 1000, such as while waiting for a data dependency to be resolved, then the active task may be evicted from the general processing cluster 1000 and returned to the pending task pool while another task in the pending task pool is selected and scheduled for execution on the general processing cluster 1000.

The work distribution unit 910 communicates with the one or more general processing cluster 1000 modules via crossbar 914. The crossbar 914 is an interconnect network that couples many of the units of the parallel processing unit 902 to other units of the parallel processing unit 902. For example, the crossbar 914 may be configured to couple the work distribution unit 910 to a particular general processing cluster 1000. Although not shown explicitly, one or more other units of the parallel processing unit 902 may also be connected to the crossbar 914 via the hub 912.

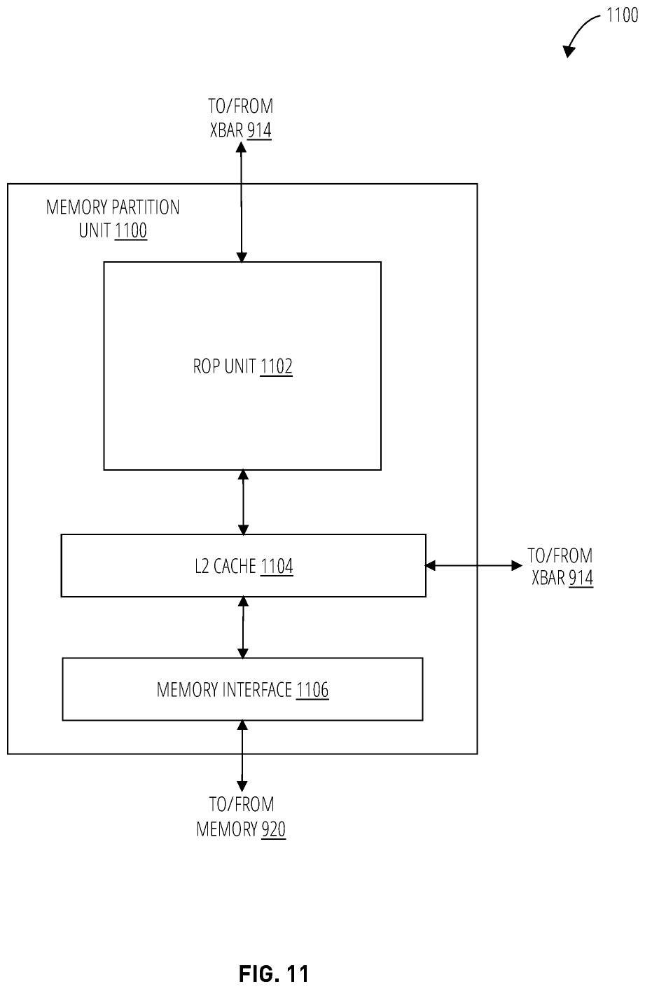

The tasks are managed by the scheduler unit 908 and dispatched to a general processing cluster 1000 by the work distribution unit 910. The general processing cluster 1000 is configured to process the task and generate results. The results may be consumed by other tasks within the general processing cluster 1000, routed to a different general processing cluster 1000 via the crossbar 914, or stored in the memory 920. The results can be written to the memory 920 via the memory partition unit 1100 modules, which implement a memory interface for reading and writing data to/from the memory 920. The results can be transmitted to another parallel processing unit 902 or CPU via the NVLink 916. In an embodiment, the parallel processing unit 902 includes a number U of memory partition unit 1100 modules that is equal to the number of separate and distinct memory 920 devices coupled to the parallel processing unit 902. A memory partition unit 1100 will be described in more detail below in conjunction with FIG. 11.

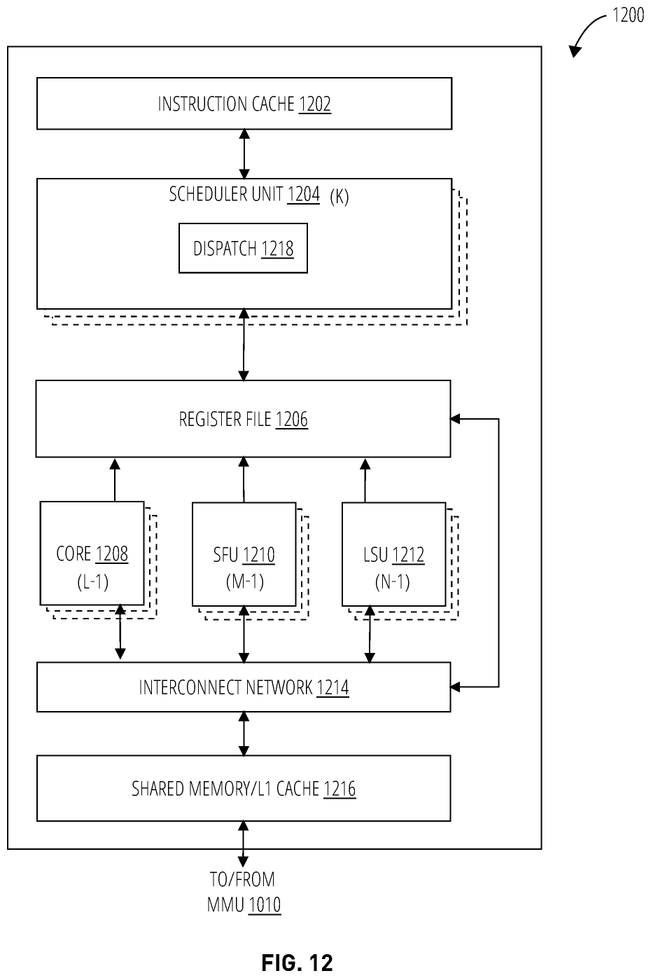

In an embodiment, a host processor executes a driver kernel that implements an application programming interface (API) that enables one or more applications executing on the host processor to schedule operations for execution on the parallel processing unit 902. In an embodiment, multiple compute applications are simultaneously executed by the parallel processing unit 902 and the parallel processing unit 902 provides isolation, quality of service (QoS), and independent address spaces for the multiple compute applications. An application may generate instructions (e.g., API calls) that cause the driver kernel to generate one or more tasks for execution by the parallel processing unit 902. The driver kernel outputs tasks to one or more streams being processed by the parallel processing unit 902. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 12.

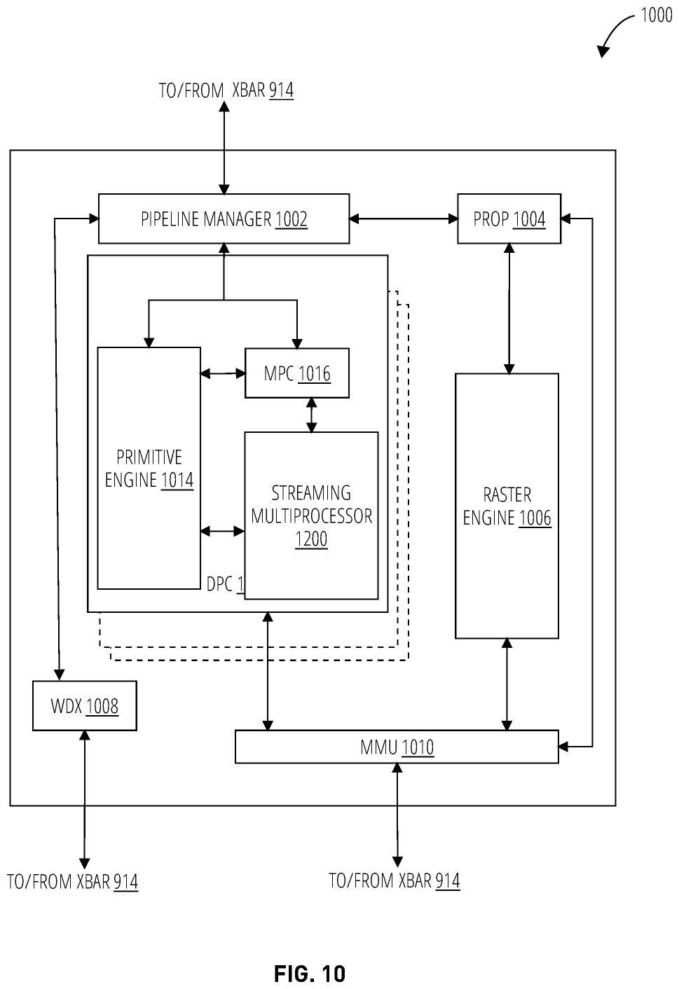

FIG. 10 depicts a general processing cluster 1000 of the parallel processing unit 902 of FIG. 9, in accordance with an embodiment. As shown in FIG. 10, each general processing cluster 1000 includes a number of hardware units for processing tasks. In an embodiment, each general processing cluster 1000 includes a pipeline manager 1002, a pre-raster operations unit 1004, a raster engine 1006, a work distribution crossbar 1008, a memory management unit 1010, and one or more data processing cluster 1012. It will be appreciated that the general processing cluster 1000 of FIG. 10 may include other hardware units in lieu of or in addition to the units shown in FIG. 10.

In an embodiment, the operation of the general processing cluster 1000 is controlled by the pipeline manager 1002. The pipeline manager 1002 manages the configuration of the one or more data processing cluster 1012 modules for processing tasks allocated to the general processing cluster 1000. In an embodiment, the pipeline manager 1002 may configure at least one of the one or more data processing cluster 1012 modules to implement at least a portion of a graphics rendering pipeline. For example, a data processing cluster 1012 may be configured to execute a vertex shader program on the programmable streaming multiprocessor 1200. The pipeline manager 1002 may also be configured to route packets received from the work distribution unit 910 to the appropriate logical units within the general processing cluster 1000. For example, some packets may be routed to fixed function hardware units in the pre-raster operations unit 1004 and/or raster engine 1006 while other packets may be routed to the data processing cluster 1012 modules for processing by the primitive engine 1014 or the streaming multiprocessor 1200. In an embodiment, the pipeline manager 1002 may configure at least one of the one or more data processing cluster 1012 modules to implement a neural network model and/or a computing pipeline.

The pre-raster operations unit 1004 is configured to route data generated by the raster engine 1006 and the data processing cluster 1012 modules to a Raster Operations (ROP) unit, described in more detail in conjunction with FIG. 11. The pre-raster operations unit 1004 may also be configured to perform optimizations for color blending, organize pixel data, perform address translations, and the like.

The raster engine 1006 includes a number of fixed function hardware units configured to perform various raster operations. In an embodiment, the raster engine 1006 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1006 comprises fragments to be processed, for example, by a fragment shader implemented within a data processing cluster 1012.

Each data processing cluster 1012 included in the general processing cluster 1000 includes an M-pipe controller 1016, a primitive engine 1014, and one or more streaming multiprocessor 1200 modules. The M-pipe controller 1016 controls the operation of the data processing cluster 1012, routing packets received from the pipeline manager 1002 to the appropriate units in the data processing cluster 1012. For example, packets associated with a vertex may be routed to the primitive engine 1014, which is configured to fetch vertex attributes associated with the vertex from the memory 920. In contrast, packets associated with a shader program may be transmitted to the streaming multiprocessor 1200.

The streaming multiprocessor 1200 comprises a programmable streaming processor that is configured to process tasks represented by a number of threads. Each streaming multiprocessor 1200 is multi-threaded and configured to execute a plurality of threads (e.g., 32 threads) from a particular group of threads concurrently. In an embodiment, the streaming multiprocessor 1200 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1200 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1200 will be described in more detail below in conjunction with FIG. 12.

The memory management unit 1010 provides an interface between the general processing cluster 1000 and the memory partition unit 1100. The memory management unit 1010 may provide translation of virtual addresses into physical addresses, memory protection, and arbitration of memory requests. In an embodiment, the memory management unit 1010 provides one or more translation lookaside buffers (TLBs) for performing translation of virtual addresses into physical addresses in the memory 920.

FIG. 11 depicts a memory partition unit 1100 of the parallel processing unit 902 of FIG. 9, in accordance with an embodiment. As shown in FIG. 11, the memory partition unit 1100 includes a raster operations unit 1102, a level two cache 1104, and a memory interface 1106. The memory interface 1106 is coupled to the memory 920. Memory interface 1106 may implement 32, 64, 128, 1024-bit data buses, or the like, for high-speed data transfer. In an embodiment, the parallel processing unit 902 incorporates U memory interface 1106 modules, one memory interface 1106 per pair of memory partition unit 1100 modules, where each pair of memory partition unit 1100 modules is connected to a corresponding memory 920 device. For example, parallel processing unit 902 may be connected to up to Y memory 920 devices, such as high bandwidth memory stacks or graphics double-data-rate, version 5, synchronous dynamic random access memory, or other types of persistent storage.

In an embodiment, the memory interface 1106 implements an HBM2 memory interface and Y equals half U. In an embodiment, the HBM2 memory stacks are located on the same physical package as the parallel processing unit 902, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 920 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 902 modules process very large datasets and/or run applications for extended periods.

In an embodiment, the parallel processing unit 902 implements a multi-level memory hierarchy. In an embodiment, the memory partition unit 1100 supports a unified memory to provide a single unified virtual address space for CPU and parallel processing unit 902 memory, enabling data sharing between virtual memory systems. In an embodiment the frequency of accesses by a parallel processing unit 902 to memory located on other processors is traced to ensure that memory pages are moved to the physical memory of the parallel processing unit 902 that is accessing the pages more frequently. In an embodiment, the NVLink 916 supports address translation services allowing the parallel processing unit 902 to directly access a CPU's page tables and providing full access to CPU memory by the parallel processing unit 902.

In an embodiment, copy engines transfer data between multiple parallel processing unit 902 modules or between parallel processing unit 902 modules and CPUs. The copy engines can generate page faults for addresses that are not mapped into the page tables. The memory partition unit 1100 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 920 or other system memory may be fetched by the memory partition unit 1100 and stored in the level two cache 1104, which is located on-chip and is shared between the various general processing cluster 1000 modules. As shown, each memory partition unit 1100 includes a portion of the level two cache 1104 associated with a corresponding memory 920 device. Lower level caches may then be implemented in various units within the general processing cluster 1000 modules. For example, each of the streaming multiprocessor 1200 modules may implement an L1 cache. The L1 cache is private memory that is dedicated to a particular streaming multiprocessor 1200. Data from the level two cache 1104 may be fetched and stored in each of the L1 caches for processing in the functional units of the streaming multiprocessor 1200 modules. The level two cache 1104 is coupled to the memory interface 1106 and the crossbar 914.

The raster operations unit 1102 performs graphics raster operations related to pixel color, such as color compression, pixel blending, and the like. The raster operations unit 1102 also implements depth testing in conjunction with the raster engine 1006, receiving a depth for a sample location associated with a pixel fragment from the culling engine of the raster engine 1006. The depth is tested against a corresponding depth in a depth buffer for a sample location associated with the fragment. If the fragment passes the depth test for the sample location, then the raster operations unit 1102 updates the depth buffer and transmits a result of the depth test to the raster engine 1006. It will be appreciated that the number of partition memory partition unit 1100 modules may be different than the number of general processing cluster 1000 modules and, therefore, each raster operations unit 1102 may be coupled to each of the general processing cluster 1000 modules. The raster operations unit 1102 tracks packets received from the different general processing cluster 1000 modules and determines which general processing cluster 1000 that a result generated by the raster operations unit 1102 is routed to through the crossbar 914. Although the raster operations unit 1102 is included within the memory partition unit 1100 in FIG. 11, in other embodiment, the raster operations unit 1102 may be outside of the memory partition unit 1100. For example, the raster operations unit 1102 may reside in the general processing cluster 1000 or another unit.

FIG. 12 illustrates the streaming multiprocessor 1200 of FIG. 10, in accordance with an embodiment. As shown in FIG. 12, the streaming multiprocessor 1200 includes an instruction cache 1202, one or more scheduler unit 1204 modules (e.g., such as scheduler unit 908), a register file 1206, one or more processing core 1208 modules, one or more special function unit 1210 modules, one or more load/store unit 1212 modules, an interconnect network 1214, and a shared memory/L1 cache 1216.

As described above, the work distribution unit 910 dispatches tasks for execution on the general processing cluster 1000 modules of the parallel processing unit 902. The tasks are allocated to a particular data processing cluster 1012 within a general processing cluster 1000 and, if the task is associated with a shader program, the task may be allocated to a streaming multiprocessor 1200. The scheduler unit 908 receives the tasks from the work distribution unit 910 and manages instruction scheduling for one or more thread blocks assigned to the streaming multiprocessor 1200. The scheduler unit 1204 schedules thread blocks for execution as warps of parallel threads, where each thread block is allocated at least one warp. In an embodiment, each warp executes 32 threads. The scheduler unit 1204 may manage a plurality of different thread blocks, allocating the warps to the different thread blocks and then dispatching instructions from the plurality of different cooperative groups to the various functional units (e.g., core 1208 modules, special function unit 1210 modules, and load/store unit 1212 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1218 unit is configured within the scheduler unit 1204 to transmit instructions to one or more of the functional units. In one embodiment, the scheduler unit 1204 includes two dispatch 1218 units that enable two different instructions from the same warp to be dispatched during each clock cycle. In alternative embodiments, each scheduler unit 1204 may include a single dispatch 1218 unit or additional dispatch 1218 units.

Each streaming multiprocessor 1200 includes a register file 1206 that provides a set of registers for the functional units of the streaming multiprocessor 1200. In an embodiment, the register file 1206 is divided between each of the functional units such that each functional unit is allocated a dedicated portion of the register file 1206. In another embodiment, the register file 1206 is divided between the different warps being executed by the streaming multiprocessor 1200. The register file 1206 provides temporary storage for operands connected to the data paths of the functional units.

Each streaming multiprocessor 1200 comprises L processing core 1208 modules. In an embodiment, the streaming multiprocessor 1200 includes a large number (e.g., 128, etc.) of distinct processing core 1208 modules. Each core 1208 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1208 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1208 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1200 also comprises M special function unit 1210 modules that perform special functions (e.g., attribute evaluation, reciprocal square root, and the like). In an embodiment, the special function unit 1210 modules may include a tree traversal unit configured to traverse a hierarchical tree data structure. In an embodiment, the special function unit 1210 modules may include texture unit configured to perform texture map filtering operations. In an embodiment, the texture units are configured to load texture maps (e.g., a 2D array of texels) from the memory 920 and sample the texture maps to produce sampled texture values for use in shader programs executed by the streaming multiprocessor 1200. In an embodiment, the texture maps are stored in the shared memory/L1 cache 1216. The texture units implement texture operations such as filtering operations using mip-maps (e.g., texture maps of varying levels of detail). In an embodiment, each streaming multiprocessor 1200 includes two texture units.

Each streaming multiprocessor 1200 also comprises N load/store unit 1212 modules that implement load and store operations between the shared memory/L1 cache 1216 and the register file 1206. Each streaming multiprocessor 1200 includes an interconnect network 1214 that connects each of the functional units to the register file 1206 and the load/store unit 1212 to the register file 1206 and shared memory/L1 cache 1216. In an embodiment, the interconnect network 1214 is a crossbar that can be configured to connect any of the functional units to any of the registers in the register file 1206 and connect the load/store unit 1212 modules to the register file 1206 and memory locations in shared memory/L1 cache 1216.

The shared memory/L1 cache 1216 is an array of on-chip memory that allows for data storage and communication between the streaming multiprocessor 1200 and the primitive engine 1014 and between threads in the streaming multiprocessor 1200. In an embodiment, the shared memory/L1 cache 1216 comprises 128KB of storage capacity and is in the path from the streaming multiprocessor 1200 to the memory partition unit 1100. The shared memory/L1 cache 1216 can be used to cache reads and writes. One or more of the shared memory/L1 cache 1216, level two cache 1104, and memory 920 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1216 enables the shared memory/L1 cache 1216 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 9, are bypassed, creating a much simpler programming model. In the general purpose parallel computation configuration, the work distribution unit 910 assigns and distributes blocks of threads directly to the data processing cluster 1012 modules. The threads in a block execute the same program, using a unique thread ID in the calculation to ensure each thread generates unique results, using the streaming multiprocessor 1200 to execute the program and perform calculations, shared memory/L1 cache 1216 to communicate between threads, and the load/store unit 1212 to read and write global memory through the shared memory/L1 cache 1216 and the memory partition unit 1100. When configured for general purpose parallel computation, the streaming multiprocessor 1200 can also write commands that the scheduler unit 908 can use to launch new work on the data processing cluster 1012 modules.

The parallel processing unit 902 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 902 is embodied on a single semiconductor substrate. In another embodiment, the parallel processing unit 902 is included in a system-on-a-chip (SoC) along with one or more other devices such as additional parallel processing unit 902 modules, the memory 920, a reduced instruction set computer (RISC) CPU, a memory management unit (MMU), a digital-to-analog converter (DAC), and the like.

In an embodiment, the parallel processing unit 902 may be included on a graphics card that includes one or more memory devices. The graphics card may be configured to interface with a PCIe slot on a motherboard of a desktop computer. In yet another embodiment, the parallel processing unit 902 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 13 is a conceptual diagram of a processing system 1300 implemented using the parallel processing unit 902 of FIG. 9, in accordance with an embodiment. The processing system 1300 includes a central processing unit 1302, switch 1304, and multiple parallel processing unit 902 modules each and respective memory 920 modules. The NVLink 916 provides high-speed communication links between each of the parallel processing unit 902 modules. Although a particular number of NVLink 916 and interconnect 918 connections are illustrated in FIG. 13, the number of connections to each parallel processing unit 902 and the central processing unit 1302 may vary. The switch 1304 interfaces between the interconnect 918 and the central processing unit 1302. The parallel processing unit 902 modules, memory 920 modules, and NVLink 916 connections may be situated on a single semiconductor platform to form a parallel processing module 1306. In an embodiment, the switch 1304 supports two or more protocols to interface between various different connections and/or links.

In another embodiment (not shown), the NVLink 916 provides one or more high-speed communication links between each of the parallel processing unit modules (parallel processing unit 902, parallel processing unit 902, parallel processing unit 902, and parallel processing unit 902) and the central processing unit 1302 and the switch 1304 interfaces between the interconnect 918 and each of the parallel processing unit modules. The parallel processing unit modules, memory 920 modules, and interconnect 918 may be situated on a single semiconductor platform to form a parallel processing module 1306. In yet another embodiment (not shown), the interconnect 918 provides one or more communication links between each of the parallel processing unit modules and the central processing unit 1302 and the switch 1304 interfaces between each of the parallel processing unit modules using the NVLink 916 to provide one or more high-speed communication links between the parallel processing unit modules. In another embodiment (not shown), the NVLink 916 provides one or more high-speed communication links between the parallel processing unit modules and the central processing unit 1302 through the switch 1304. In yet another embodiment (not shown), the interconnect 918 provides one or more communication links between each of the parallel processing unit modules directly. One or more of the NVLink 916 high-speed communication links may be implemented as a physical NVLink interconnect or either an on-chip or on-die interconnect using the same protocol as the NVLink 916.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1306 may be implemented as a circuit board substrate and each of the parallel processing unit modules and/or memory 920 modules may be packaged devices. In an embodiment, the central processing unit 1302, switch 1304, and the parallel processing module 1306 are situated on a single semiconductor platform.

In an embodiment, the signaling rate of each NVLink 916 is 20 to 25 Gigabits/second and each parallel processing unit module includes six NVLink 916 interfaces (as shown in FIG. 13, five NVLink 916 interfaces are included for each parallel processing unit module). Each NVLink 916 provides a data transfer rate of 25 Gigabytes/second in each direction, with six links providing 300 Gigabytes/second. The NVLink 916 can be used exclusively for PPU-to-PPU communication as shown in FIG. 13, or some combination of PPU-to-PPU and PPU-to-CPU, when the central processing unit 1302 also includes one or more NVLink 916 interfaces.

In an embodiment, the NVLink 916 allows direct load/store/atomic access from the central processing unit 1302 to each parallel processing unit module's memory 920. In an embodiment, the NVLink 916 supports coherency operations, allowing data read from the memory 920 modules to be stored in the cache hierarchy of the central processing unit 1302, reducing cache access latency for the central processing unit 1302. In an embodiment, the NVLink 916 includes support for Address Translation Services (ATS), enabling the parallel processing unit module to directly access page tables within the central processing unit 1302. One or more of the NVLink 916 may also be configured to operate in a low-power mode.

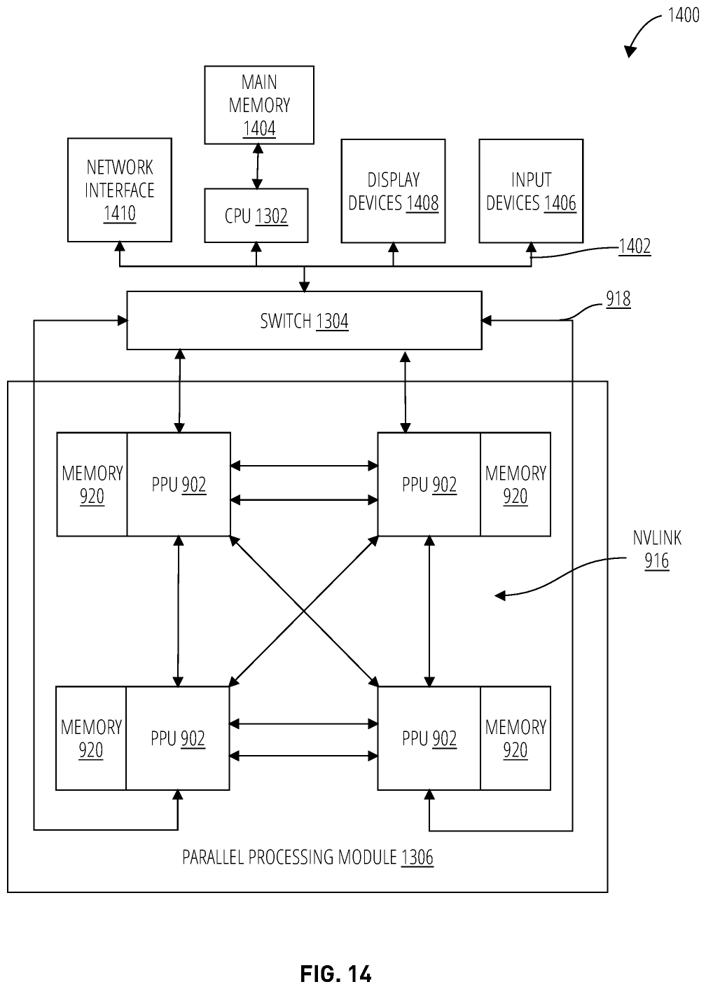

FIG. 14 depicts an exemplary processing system 1400 in which the various architecture and/or functionality of the various previous embodiments may be implemented. As shown, an exemplary processing system 1400 is provided including at least one central processing unit 1302 that is connected to a communications bus 1402. The communication communications bus 1402 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1400 also includes a main memory 1404. Control logic (software) and data are stored in the main memory 1404 which may take the form of random access memory (RAM).

The exemplary processing system 1400 also includes input devices 1406, the parallel processing module 1306, and display devices 1408, e.g. a conventional CRT (cathode ray tube), LCD (liquid crystal display), LED (light emitting diode), plasma display or the like. User input may be received from the input devices 1406, e.g., keyboard, mouse, touchpad, microphone, and the like. Each of the foregoing modules and/or devices may even be situated on a single semiconductor platform to form the exemplary processing system 1400. Alternately, the various modules may also be situated separately or in various combinations of semiconductor platforms per the desires of the user.

Further, the exemplary processing system 1400 may be coupled to a network (e.g., a telecommunications network, local area network (LAN), wireless network, wide area network (WAN) such as the Internet, peer-to-peer network, cable network, or the like) through a network interface 1410 for communication purposes.

The exemplary processing system 1400 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1404 and/or the secondary storage. Such computer programs, when executed, enable the exemplary processing system 1400 to perform various functions. The main memory 1404, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1400 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

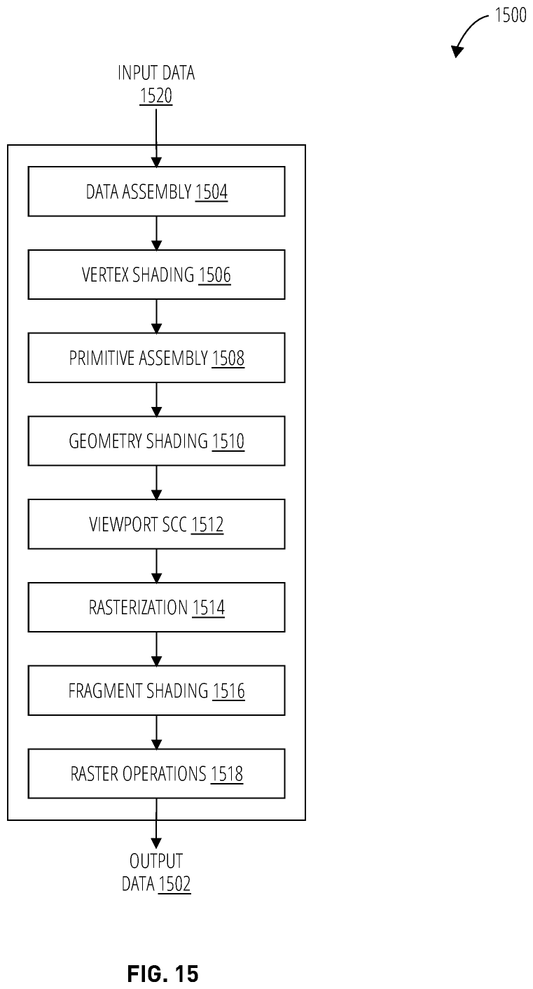

FIG. 15 is a conceptual diagram of a graphics processing pipeline 1500 implemented by the parallel processing unit 902 of FIG. 9, in accordance with an embodiment. In an embodiment, the parallel processing unit 902 comprises a graphics processing unit (GPU). The parallel processing unit 902 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 902 can be configured to process the graphics primitives to generate a frame buffer (e.g., pixel data for each of the pixels of the display).

An application writes model data for a scene (e.g., a collection of vertices and attributes) to a memory such as a system memory or memory 920. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 1200 modules of the parallel processing unit 902 including one or more of a vertex shader, hull shader, domain shader, geometry shader, and a pixel shader. For example, one or more of the streaming multiprocessor 1200 modules may be configured to execute a vertex shader program that processes a number of vertices defined by the model data. In an embodiment, the different streaming multiprocessor 1200 modules may be configured to execute different shader programs concurrently. For example, a first subset of streaming multiprocessor 1200 modules may be configured to execute a vertex shader program while a second subset of streaming multiprocessor 1200 modules may be configured to execute a pixel shader program. The first subset of streaming multiprocessor 1200 modules processes vertex data to produce processed vertex data and writes the processed vertex data to the level two cache 1104 and/or the memory 920. After the processed vertex data is rasterized (e.g., transformed from three-dimensional data into two-dimensional data in screen space) to produce fragment data, the second subset of streaming multiprocessor 1200 modules executes a pixel shader to produce processed fragment data, which is then blended with other processed fragment data and written to the frame buffer in memory 920. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline 1500 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 1500 receives input data 601 that is transmitted from one stage to the next stage of the graphics processing pipeline 1500 to generate output data 1502. In an embodiment, the graphics processing pipeline 1500 may represent a graphics processing pipeline defined by the OpenGL® API. As an option, the graphics processing pipeline 1500 may be implemented in the context of the functionality and architecture of the previous Figures and/or any subsequent Figure(s).

As shown in FIG. 15, the graphics processing pipeline 1500 comprises a pipeline architecture that includes a number of stages. The stages include, but are not limited to, a data assembly 1504 stage, a vertex shading 1506 stage, a primitive assembly 1508 stage, a geometry shading 1510 stage, a viewport SCC 1512 stage, a rasterization 1514 stage, a fragment shading 1516 stage, and a raster operations 1518 stage. In an embodiment, the input data 1520 comprises commands that configure the processing units to implement the stages of the graphics processing pipeline 1500 and geometric primitives (e.g., points, lines, triangles, quads, triangle strips or fans, etc.) to be processed by the stages. The output data 1502 may comprise pixel data (e.g., color data) that is copied into a frame buffer or other type of surface data structure in a memory.

The data assembly 1504 stage receives the input data 1520 that specifies vertex data for high-order surfaces, primitives, or the like. The data assembly 1504 stage collects the vertex data in a temporary storage or queue, such as by receiving a command from the host processor that includes a pointer to a buffer in memory and reading the vertex data from the buffer. The vertex data is then transmitted to the vertex shading 1506 stage for processing.

The vertex shading 1506 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 1506 stage may manipulate individual vertex attributes such as position, color, texture coordinates, and the like. In other words, the vertex shading 1506 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 1506 stage generates transformed vertex data that is transmitted to the primitive assembly 1508 stage.

The primitive assembly 1508 stage collects vertices output by the vertex shading 1506 stage and groups the vertices into geometric primitives for processing by the geometry shading 1510 stage. For example, the primitive assembly 1508 stage may be configured to group every three consecutive vertices as a geometric primitive (e.g., a triangle) for transmission to the geometry shading 1510 stage. In some embodiments, specific vertices may be reused for consecutive geometric primitives (e.g., two consecutive triangles in a triangle strip may share two vertices). The primitive assembly 1508 stage transmits geometric primitives (e.g., a collection of associated vertices) to the geometry shading 1510 stage.

The geometry shading 1510 stage processes geometric primitives by performing a set of operations (e.g., a geometry shader or program) on the geometric primitives. Tessellation operations may generate one or more geometric primitives from each geometric primitive. In other words, the geometry shading 1510 stage may subdivide each geometric primitive into a finer mesh of two or more geometric primitives for processing by the rest of the graphics processing pipeline 1500. The geometry shading 1510 stage transmits geometric primitives to the viewport SCC 1512 stage.

In an embodiment, the graphics processing pipeline 1500 may operate within a streaming multiprocessor and the vertex shading 1506 stage, the primitive assembly 1508 stage, the geometry shading 1510 stage, the fragment shading 1516 stage, and/or hardware/software associated therewith, may sequentially perform processing operations. Once the sequential processing operations are complete, in an embodiment, the viewport SCC 1512 stage may utilize the data. In an embodiment, primitive data processed by one or more of the stages in the graphics processing pipeline 1500 may be written to a cache (e.g. L1 cache, a vertex cache, etc.). In this case, in an embodiment, the viewport SCC 1512 stage may access the data in the cache. In an embodiment, the viewport SCC 1512 stage and the rasterization 1514 stage are implemented as fixed function circuitry.

The viewport SCC 1512 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 1514 stage.

The rasterization 1514 stage converts the 3D geometric primitives into 2D fragments (e.g. capable of being utilized for display, etc.). The rasterization 1514 stage may be configured to utilize the vertices of the geometric primitives to setup a set of plane equations from which various attributes can be interpolated. The rasterization 1514 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 1514 stage generates fragment data (e.g., interpolated vertex attributes associated with a particular sample location for each covered pixel) that are transmitted to the fragment shading 1516 stage.

The fragment shading 1516 stage processes fragment data by performing a set of operations (e.g., a fragment shader or a program) on each of the fragments. The fragment shading 1516 stage may generate pixel data (e.g., color values) for the fragment such as by performing lighting operations or sampling texture maps using interpolated texture coordinates for the fragment. The fragment shading 1516 stage generates pixel data that is transmitted to the raster operations 1518 stage.

The raster operations 1518 stage may perform various operations on the pixel data such as performing alpha tests, stencil tests, and blending the pixel data with other pixel data corresponding to other fragments associated with the pixel. When the raster operations 1518 stage has finished processing the pixel data (e.g., the output data 1502), the pixel data may be written to a render target such as a frame buffer, a color buffer, or the like.

It will be appreciated that one or more additional stages may be included in the graphics processing pipeline 1500 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 1510 stage). Other types of graphics processing pipelines are contemplated as being within the scope of the present disclosure. Furthermore, any of the stages of the graphics processing pipeline 1500 may be implemented by one or more dedicated hardware units within a graphics processor such as parallel processing unit 902. Other stages of the graphics processing pipeline 1500 may be implemented by programmable hardware units such as the streaming multiprocessor 1200 of the parallel processing unit 902.

The graphics processing pipeline 1500 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 902. The API provides an abstraction for a programmer that lets a programmer utilize specialized graphics hardware, such as the parallel processing unit 902, to generate the graphical data without requiring the programmer to utilize the specific instruction set for the parallel processing unit 902. The application may include an API call that is routed to the device driver for the parallel processing unit 902. The device driver interprets the API call and performs various operations to respond to the API call. In some instances, the device driver may perform operations by executing instructions on the CPU. In other instances, the device driver may perform operations, at least in part, by launching operations on the parallel processing unit 902 utilizing an input/output interface between the CPU and the parallel processing unit 902. In an embodiment, the device driver is configured to implement the graphics processing pipeline 1500 utilizing the hardware of the parallel processing unit 902.

Various programs may be executed within the parallel processing unit 902 in order to implement the various stages of the graphics processing pipeline 1500. For example, the device driver may launch a kernel on the parallel processing unit 902 to perform the vertex shading 1506 stage on one streaming multiprocessor 1200 (or multiple streaming multiprocessor 1200 modules). The device driver (or the initial kernel executed by the parallel processing unit 902) may also launch other kernels on the parallel processing unit 902 to perform other stages of the graphics processing pipeline 1500, such as the geometry shading 1510 stage and the fragment shading 1516 stage. In addition, some of the stages of the graphics processing pipeline 1500 may be implemented on fixed unit hardware such as a rasterizer or a data assembler implemented within the parallel processing unit 902. It will be appreciated that results from one kernel may be processed by one or more intervening fixed function hardware units before being processed by a subsequent kernel on a streaming multiprocessor 1200.

### CODE LISTINGS

Listing 1 - LNS-Madam algorithm
Algorithm 1 LNS-Madam

```
Require: weight W, weight exponents \tilde{W}, base factor γ,
learning rate η, first momentum β₁, second momentum
β₂, bitwidth of weight update [symbol]   _{U}
Initialize \tilde{g}₁, \tilde{g}₂ ← 0
repeat
  g ← StockasticGradient( )
  \tilde{g}₁ ← (1 − β₁)g + β₁\tilde{g}₁
  \tilde{g}₂ ← (1 − β₂)g² + B₂\tilde{g}₂
  g* ← \tilde{g}₁/√\tilde{g}₂
  \tilde{W} ← \tilde{W} − γ η sign(W) ⊙ g*
  \tilde{W} ← clamp( round( W), 0, 2 [symbol]   ^{_{U}}⁻¹ − 1)
until converged
```

### LISTING OF DRAWING ELEMENTS

100 basic deep neural network
102 loss function
104 input layer
106 output layer
108 hidden layers
200 artificial neuron
202 activation function
204 weight update function
400 training algorithm data flow
402 forward pass
404 backward pass
406 loss algorithm L
408 weight update
502 neural network training and inference system
504 computing system
506 vehicle
508 robot
600 data center
602 data center infrastructure layer
604 framework layer
606 software layer
608 application layer
610 resource orchestrator
612 grouped computing resources
614a node C.R.
614b node C.R.
614c node C.R.
616 job scheduler
618 configuration manager
620 resource manager
622 distributed file system
624 software
626 application(s)
700 neural network processor
702 processing elements
704 global buffer
706 controller
708 router
800 processing element
802 vector multiply-accumulate units
804 weight buffer
806 activation buffer
808 router
810 controller
812 accumulation memory buffer
814 post-processor
902 parallel processing unit
904 I/O unit
906 front-end unit
908 scheduler unit
910 work distribution unit
912 hub
914 crossbar
916 NVLink
918 interconnect
920 memory
1000 general processing cluster
1002 pipeline manager
1004 pre-raster operations unit
1006 raster engine
1008 work distribution crossbar
1010 memory management unit
1012 data processing cluster
1014 primitive engine
1016 M-pipe controller
1100 memory partition unit
1102 raster operations unit
1104 level two cache
1106 memory interface
1200 streaming multiprocessor
1202 instruction cache
1204 scheduler unit
1206 register file
1208 core
1210 special function unit
1212 load/store unit
1214 interconnect network
1216 shared memory/L1 cache
1218 dispatch
1300 processing system
1302 central processing unit
1304 switch
1306 parallel processing module
1400 exemplary processing system
1402 communications bus
1404 main memory
1406 input devices
1408 display devices
1410 network interface
1500 graphics processing pipeline
1502 output data
1504 data assembly
1506 vertex shading
1508 primitive assembly
1510 geometry shading
1512 viewport SCC
1514 rasterization
1516 fragment shading
1518 raster operations
1520 input data

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.0 § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A system comprising:
a neural network; and
logic to apply a multi-base logarithmic number system to update weights of the neural network.

2. The system of claim 1, further comprising logic to apply a multiplicative update to the weights in a logarithmic representation.

3. The system of claim 1, the logic to update weights W from iteration t to iteration t+1 comprising:
\tilde{W}ₜ₊₁=\tilde{W}ₜ−ηsign(Wₜ)⊙gₜ*
where ⊙ denotes element-wise multiplication, and
$${g}_{t}^{*} = / \sqrt{}$$
where [symbol] is a first-order gradient estimate for weight updates and [symbol] is a second-order gradient estimate for the weight updates.

4. The system of claim 1, further comprising logic to utilize a logarithmic quantization algorithm (LogQuant) for the weight updates, comprising:
LogQuant(χ, s, γ, β)=sign(χ)×s× [symbol]
where
\tilde{χ}==clamp(round(log₂(|χ|/s)χγ), 0, 2^{β-1}−1)
where s comprises a scale factor that maps a real value x into an integer exponent, γ is a base factor of the multi-base logarithmic number system, and β is an integer.

5. The system of claim 1, wherein the multi-base logarithmic number system comprises a fractional power-of-two log base.

6. The system of claim 5, wherein a log base x is determined according to:
χ=sign×2^{\tilde{x}/γ}, χ=0, 1, 2, . . . , 2^{β-1}−1
where \tilde{χ} is an integer of bitwidth β−1 and γ=2^{b} where b is a non-negative integer.

7. The system of claim 1, further comprising logic to apply a lookup table and left shift operations to approximate additions in the multi-base logarithmic number system during weight updates.

8. The system of claim 1, further comprising:
a backpropagation path coupling an output generated by the neural network to a plurality of layers of the neural network; and
a feed-forward path through the layers of the neural network;
wherein the backpropagation path, the feed-forward path, and the weight updates are configured for low-precision computation.

9. The system of claim 8, wherein the low-precision computation comprises calculation with 8-bit values in the feed-forward path and 5-bit values in the backpropagation path.

10. A system comprising:
a neural network; and
logic to apply a multi-base logarithmic number system to update weights of the neural network during a training of the neural network;
wherein a base of the multi-base logarithmic number system is a power of two varied in the neural network during the training.

11. The system of claim 10, further comprising logic to apply a multiplicative update to the weights in a logarithmic representation.

12. The system of claim 10, wherein the base of the multi-base logarithmic number system is denoted by χ and is determined according to
χ=sign×2^{\tilde{χ}/γ}, \tilde{χ}=0,1, 2, . . . , 2^{β-1}−1
where \tilde{χ} is an integer of bitwidth β−1 and γ=2^{b} where b is a non-negative integer.

13. The system of claim 12, wherein x is different for weight update calculation, backward propagation calculation, and forward activation calculation.

14. The system of claim 10, further comprising logic to utilize a logarithmic quantization algorithm (LogQuant) for weight updates, comprising:
LogQuant(x, s, γ, β)=sign (χ)×s× [symbol]
where
\tilde{χ}=clamp(round(log₂(log₂(|χ|/s), 0, 2^{β-1}−1)
where s comprises a scale factor that maps a real value x into an integer exponent, γ is a base factor of the multi-base logarithmic number system, and β is an integer.

15. The system of claim 10, further comprising logic to apply a lookup table and left shift operations to approximate additions in the multi-base logarithmic number system during weight updates.

16. A method for training a neural network comprising:
applying a multi-base logarithmic number system to update weights of the neural network; and
utilizing different bases for the multi-base logarithmic number system between calculation of weight updates, calculation of feed-forward signals, and calculation of feedback signals.

17. The method of claim 16, further comprising:
apply multiplicative updates to the weights in a logarithmic representation.

18. The method of claim 16, wherein weights W are updated from an iteration t to an iteration t+1 of the training according to:
\tilde{W}ₜ₊₁=\tilde{W}ₜ−ηsign(Wₜ)⊙gₜ*
where ⊙ denotes element-wise multiplication, and
$${g}_{t}^{*} = / \sqrt{}$$
where [symbol] is a first-order gradient estimate for the weight updates and [symbol] is a second-order gradient estimate for the weight updates.

19. The method of claim 16, further comprising utilizing a logarithmic quantization algorithm (LogQuant) for the weight updates according to:
LogQuant(χ, s, γ, β)=sign (χ)×s× [symbol]
where
\tilde{χ}=clamp(round(log₂(log₂(|χ|/s)χγ), 0, 2^{β-1}−1)
where s comprises a scale factor that maps a real value χ into an integer exponent, γ is a base factor of the multi-base logarithmic number system, and β is an integer.

20. The method of claim 19, wherein a log base χ is determined according to:
χ=sign×2^{\tilde{χ}/γ}, \tilde{χ}=0, 1, 2, . . . , 2^{β-1}−1
where \tilde{χ} is an integer of bitwidth β−1 and γ=2^{b} where b is a non-negative integer.
